(19) United States
(12) Patent Application Publication
(10) Pub. No.: US 2025/0269877 A1
(43) Pub. Date: Aug. 28, 2025

(54) Long-Horizon Trajectory Determination for Vehicle Motion Planning

(71) Applicant: Aurora Operations, Inc., Pittsburgh, PA (US)

(72) Inventors: J. Andrew Bagnell, Pittsburgh, PA (US); Michael Bode, Pittsburgh, PA (US); Ashwin Carvalho, Santa Clara, CA (US); Evan Honnold, Pittsburgh, PA (US); Shervin Javdani, San Francisco, CA (US); Pengju Jin, San Francisco, CA (US); Venkatraman Narayanan, Mountain View, CA (US); Arun Venkatraman, Mountain View, CA (US); Carl Wellington, Pittsburgh, PA (US)

(21) Appl. No.: 19/006,709

(22) Filed: Dec. 31, 2024

Related U.S. Application Data
(60) Provisional application No. 63/558,247, filed on Feb. 27, 2024.

(51) Int. Cl. B60W 60/00

(52) U.S. Cl. CPC B60W 60/0015

(57) ABSTRACT

An example method includes (a) obtaining sensor data descriptive of an environment of an autonomous vehicle; (b) determining a plurality of short-term trajectories based on the sensor data; (c) determining a plurality of long-term trajectories based on the sensor data; (d) generating a first trajectory pairing based on the first short-term trajectory and the first long-term trajectory; and (e) determining, from among the plurality of short-term trajectories, a short-term trajectory for execution by the autonomous vehicle based on the first trajectory pairing.

### PRIORITY CLAIM

The present application is based on and claims priority to U.S. Provisional Application No. 63/558,247 having a filing date of Feb. 27, 2024. Applicant claims priority to and the benefit of such application and incorporates such application herein by reference in its entirety.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

Example implementations of the present disclosure can improve the ability of an autonomous vehicle to plan its short-term motion in a manner that accounts for longer-horizon forecasts. Longer-horizon forecasts may include forecasts that account for what other actors may do, what options the autonomous vehicle could do in the future (e.g., nudge, lane change, slow down, or speed up), future map content the autonomous vehicle will interact with, or what route the autonomous vehicle should take (e.g., should the autonomous vehicle take an exit or continue, take a turn or go straight in an intersection). To do so, the autonomous vehicle can generate short-term trajectories and separate long-term trajectories in parallel and combine them to create trajectory pairings. As further described herein, these trajectories pairings can be used to plan the vehicle's short term motion while understanding potential longer horizon impacts. This allows the autonomous vehicle to move towards one single motion planning layer that considers multiple options and strategies in a single global cost function.

For example, an autonomous vehicle can obtain sensor data descriptive of an environment of the autonomous vehicle. The autonomous vehicle can process the sensor data to perceive objects within its environment. This may include, for example, a vehicle that is merging from an exit ramp into the lane in which the autonomous vehicle is currently traveling. The autonomous vehicle can determine that it will execute a strategy (e.g., a maneuver) that involves performing a courtesy lane change to provide additional space for the merging vehicle.

The autonomous vehicle's motion planner can continuously generate short-term trajectories based on the sensor data and selected strategy. A short-term trajectory can be descriptive of a candidate short-term motion path for the autonomous vehicle from an initial state to a first end state that avoids interference with the objects within the environment. For example, a short-term trajectory can provide a series of waypoints, motion constraints, etc. for the autonomous vehicle to execute over the next few seconds spanning from the initial state (e.g., the current time (t0)) to the first end state (e.g., 5 seconds later (t0+5 s)).

To help understand the longer-horizon impacts of the vehicle's motion toward meeting its strategic goal, the autonomous vehicle can also generate long-term trajectories. The long-term trajectories can be determined in parallel to the short-term trajectories, but can be separate from the short-term trajectories. A long-term trajectory can be descriptive of a candidate long-term motion path for the autonomous vehicle that spans from the initial state (e.g., the current state) to a second end state (e.g., 25 seconds later (t0+25 s)). The second end state of the long term trajectories is after the first end state of the short-term trajectories such that the long-term trajectories span a longer time than the short-term trajectories.

The autonomous vehicle can generate the long-term trajectories in a manner that helps to reduce potential latency. For example, the autonomous vehicle can limit the number of long-term trajectories that are produced such that they are less than (e.g., by 50%, by an order of magnitude) the number of short-term trajectories produced. In some implementations, the long-term trajectories can be sparser/lower resolution than the short-term trajectories. By way of example, the long-term trajectories may include fewer or less frequent waypoints than the short-term trajectories. This reduction in granularity helps leverage temporal discounting to balance the uncertainty that accompanies longer-term forecasts, while still allowing the autonomous vehicle to properly utilize the long-term trajectories to understand potential future impacts on meeting the desired strategy.

To take advantage of the granularity of the short-term trajectories and the forward looking nature of the long-term trajectories, the autonomous vehicle can develop short-long trajectory pairings that are an aggregate of the respective short-term and long-term trajectories. For instance, the autonomous vehicle can determine that a particular short-term trajectory is associated with a particular long-term trajectory. This can be accomplished by comparing the time and spatial dimensions of the trajectories to determine which long-term trajectory is the closest (e.g., nearest neighbor) to the particular short-term trajectory. This can be, for example, the long-term trajectory that is closest in time and space to the final waypoint of the particular short-term trajectory.

The autonomous vehicle can generate a trajectory pairing based on the associated short-term trajectory and the long-term trajectory. The trajectory pairings can include a first portion and a second portion. The first portion can be a denser portion (e.g., with more waypoints) and can be defined by the short-term trajectory that spans from the initial state to the first end state (e.g., 0-5 s). The second portion can be defined by the segment of the long-term trajectory that spans from the first end state to the second end state (e.g., 5-25 s). The trajectory pairing allows the autonomous vehicle to maintain the fine-grain features of the short-term trajectories while also leveraging the foresight of the long-term trajectories.

The autonomous vehicle can generate a plurality of trajectory pairings and determine a single global cost for each pairing. This global cost analysis can inform the autonomous vehicle of the long-term impact that a particular short-term trajectory may have on trying to meet the strategic goal (e.g., a courtesy lane change). Based on the cost analysis of the trajectory pairings, the autonomous vehicle can select a short-term trajectory and control its motion accordingly.

The techniques of the present disclosure can provide a number of technical effects and benefits that improve the functioning of the autonomous vehicle and its computing systems. For example, strategic value determination for short-term predictions can provide for cost determinations that may consider and forecast the immediate impact; however, long-term effects can cause certain actions to be strategically inefficient. For instance, a short-term prediction may indicate that a particular action is optimal; however, a long-term prediction may indicate a high likelihood of extended stopping, heavy maneuvering, and/or other effects that may be inefficient for the autonomous vehicle. Long-term predictions alone may be able to provide greater insight on long-term effects but may suffer in quantity and/or quality of the short-term prediction. By leveraging both short-term and long-term predictions, autonomous vehicles can make precise actions while being aware of long-term implications.

By extension, an action determination can include a plurality of long-term branches for a particular short-term action that can be evaluated to perform motion planning. In this manner, the prediction system can perform an in-depth analysis of resource consumption for a plurality of candidate actions, which may change the decision made as compared to if short-term predictions alone were considered.

By generating long-horizon trajectories according to the technology described herein, an autonomous vehicle can achieve accurate short-term predictions while including long-term impacts. For instance, a plurality of machine-learned models (e.g., a plurality of graph neural networks) can be utilized in parallel to generate short-term trajectories and long-term trajectories in unison, which can save on time for motion planning, while maintaining the quality of the machine-learned model predictions.

Moreover, the disclosed technology can further improve the operation of the vehicle by improving the fuel efficiency of a vehicle. For example, more accurate and/or precise prediction of trajectories can result in a shorter travel path and/or a travel path that requires less vehicle steering and/or acceleration, thereby achieving a reduction in the amount of energy (e.g., fuel or battery power) that is required to operate the vehicle.

Accordingly, the improvements offered by the disclosed technology result in tangible benefits to a variety of systems including the mechanical, electronic, and/or computing systems of autonomous devices. Additionally, autonomous vehicles can increase range and quality of trajectory predictions that can then be evaluated for motion planning, improving functionality and ultimately improving the pace of adoption of the emerging technology of autonomous vehicles.

The techniques of the present disclosure can provide a number of technical effects and benefits that improve the functioning of the autonomous vehicle and its computing systems and advance the field of autonomous driving as a whole.

In an aspect, the present disclosure provides an example method for autonomous vehicle motion planning and control. The example method includes obtaining sensor data descriptive of an environment of an autonomous vehicle. The example method includes determining a plurality of short-term trajectories based on the sensor data. The plurality of short-term trajectories includes a first short-term trajectory that is descriptive of a first candidate short-term motion path for the autonomous vehicle from an initial state to a first end state. The example method includes determining a plurality of long-term trajectories based on the sensor data. The plurality of long-term trajectories includes a first long-term trajectory that is descriptive of a first candidate long-term motion path for the autonomous vehicle from the initial state to a second end state. A time span between the initial state and the second end state is longer than a time span between the initial state and the first end state. The example method includes generating a first trajectory pairing based on the first short-term trajectory and the first long-term trajectory. The trajectory pairing includes a first portion that is defined by the short-term trajectory that spans from the initial state to the first end state and a second portion that is defined by a segment of the long-term trajectory that spans from the first end state to the second end state. The example method includes determining, from among the plurality of short-term trajectories, a short-term trajectory for execution by the autonomous vehicle based on the first trajectory pairing.

In some implementations, generating the first trajectory pairing includes determining that the first short-term trajectory is associated with the first long-term trajectory based on a time dimension and a spatial dimension. In some implementations, the long-term trajectory is the closest, of the plurality of long-term trajectories, to the short-term trajectory with respect to the time dimension and the spatial dimension.

In some implementations, the initial state is associated with an initial time. In some implementations, the first end state of the first short-term trajectory is associated with a first time. In some implementations, the second end state of the second long-term trajectory is associated with a second time that is after the first time. In some implementations, generating the first trajectory pairing based on the first short-term trajectory and the first long-term trajectory includes generating the first portion of the first trajectory pairing based on the first short-term trajectory spanning from the initial time to the first time; parsing, based on the first time, the long-term trajectory into a first segment that spans from the initial time to the first time and a second segment that spans from the first time to the second time; and generating the second portion of the first trajectory pairing based on the second segment of the long-term trajectory.

In some implementations, the example method includes generating cost data associated with the first trajectory pairing. In some implementations, determining a short-term trajectory for execution includes determining, from among the plurality of short-term trajectories, the short-term trajectory for execution by the autonomous vehicle based on the cost data associated with first trajectory pairing. In some implementations, the cost data is generated based part on a prediction of whether the first trajectory pairing causes the autonomous vehicle to pass an adjacent vehicle. In some implementations, the cost data is generated based on a prediction of whether the first trajectory pairing causes the autonomous vehicle to be within a threshold distance of another vehicle in a same lane as the autonomous vehicle. In some implementations, the cost data is descriptive of a plurality of subcosts. In some implementations, the plurality of subcosts are associated with a plurality of different candidate route attributes. In some implementations, the plurality of different candidate route attributes include one or more candidate route attributes that are associated with at least one of a vehicle inefficiency, a driving hazard, or route inefficiency. In some implementations, the cost data is descriptive of a determined proximity to one or more other objects in the environment for the first trajectory pairing and a determined fuel consumption for the first trajectory pairing.

In some implementations, the plurality of long-term trajectories are determined based on strategy data associated with a motion goal of the autonomous vehicle. In some implementations, the plurality of short-term trajectories include a second short-term trajectory that is descriptive of a second candidate short-term motion path for the autonomous vehicle. In some implementations, the plurality of long-term trajectories include a second long-term trajectory that is descriptive of a second candidate long-term motion path for the autonomous vehicle. In some implementations, the example method includes generating a second trajectory pairing based on the second short-term trajectory and the second long-term trajectory. In some implementations, determining, from among the plurality of short-term trajectories, a short-term trajectory for execution includes determining the short-term trajectory for execution by the autonomous vehicle based on the first trajectory pairing and the second trajectory pairing.

In some implementations, the plurality of short-term trajectories and the long-term trajectory are determined separately.

In some implementations, the plurality of short-term trajectories and the long-term trajectory are determined in parallel.

In some implementations, the quantity of short-term trajectories within the plurality of short-term trajectories is greater than the quantity of long-term trajectories within the plurality of long-term trajectories.

In some implementations, the example method includes controlling a motion of the autonomous vehicle based on the short-term trajectory determined for execution by the autonomous vehicle. In some implementations, controlling the motion of the autonomous vehicle includes providing one or more signals for the autonomous vehicle to operate in accordance with the short-term trajectory determined for execution by the autonomous vehicle.

In some implementations, determining the plurality of short-term trajectories based on the sensor data includes processing the sensor data with a machine-learned graph neural network model to determine the plurality of short-term trajectories.

In an aspect, the present disclosure provides an example autonomous vehicle control system for controlling an autonomous vehicle. In some implementations, the example autonomous vehicle control system includes one or more processors and one or more non-transitory computer-readable media storing instructions that are executable by the one or more processors to cause the computing system to perform operations. The operations include obtaining sensor data descriptive of an environment of an autonomous vehicle. The operations include determining a plurality of short-term trajectories based on the sensor data. The plurality of short-term trajectories include a first short-term trajectory that is descriptive of a first candidate short-term motion path for the autonomous vehicle from an initial state to a first end state. The operations include determining a plurality of long-term trajectories based on the sensor data. The plurality of long-term trajectories include a first long-term trajectory that is descriptive of a first candidate long-term motion path for the autonomous vehicle from the initial state to a second end state. A time span between the initial state and the second end state is longer than a time span between the initial state and the first end state. The operations include generating a first trajectory pairing based on the first short-term trajectory and the first long-term trajectory. The trajectory pairing includes a first portion that is defined by the short-term trajectory that spans from the initial state to the first end state and a second portion that is defined by a segment of the long-term trajectory that spans from the first end state to the second end state. The operations include determining, from among the plurality of short-term trajectories, a short-term trajectory for execution by the autonomous vehicle based on the first trajectory pairing.

In an aspect, the present disclosure provides for one or more example non-transitory computer-readable media storing instructions that are executable to cause one or more processors to perform operations. The operations include obtaining sensor data descriptive of an environment of an autonomous vehicle. The operations include determining a plurality of short-term trajectories based on the sensor data. The plurality of short-term trajectories include a first short-term trajectory that is descriptive of a first candidate short-term motion path for the autonomous vehicle from an initial state to a first end state. The operations include determining a plurality of long-term trajectories based on the sensor data. The plurality of long-term trajectories include a first long-term trajectory that is descriptive of a first candidate long-term motion path for the autonomous vehicle from the initial state to a second end state. A time span between the initial state and the second end state is longer than a time span between the initial state and the first end state. The operations include generating a first trajectory pairing based on the first short-term trajectory and the first long-term trajectory. The trajectory pairing includes a first portion that is defined by the short-term trajectory that spans from the initial state to the first end state and a second portion that is defined by a segment of the long-term trajectory that spans from the first end state to the second end state. The operations include determining, from among the plurality of short-term trajectories, a short-term trajectory for execution by the autonomous vehicle based on the first trajectory pairing.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 3E is an illustration of example trajectories for an autonomous vehicle in an environment, according to some implementations of the present disclosure;

FIG. 3F is an illustration of an example first trajectory effect, according to some implementations of the present disclosure;

FIG. 3G is an illustration of an example second trajectory effect, according to some implementations of the present disclosure;

FIG. 3H is an illustration of an example third trajectory effect, according to some implementations of the present disclosure;

FIG. 4A is a block diagram of an example system for long-horizon-based motion planning, according to some implementations of the present disclosure;

FIG. 4B is an illustration of example trajectory paths with a plurality of states, according to some implementations of the present disclosure;

FIG. 5 is a block diagram of an example data flow for trajectory selection, according to some implementations of the present disclosure;

FIG. 6A is an illustration of example trajectory paths, according to some implementations of the present disclosure;

FIG. 6B is an illustration of example short-horizon costs and long-horizon costs, according to some implementations of the present disclosure;

FIG. 6C is a block diagram of an example system for motion planning, according to some implementations of the present disclosure;

FIG. 7 is a flowchart of an example method for trajectory selection, according to some implementations of the present disclosure;

FIG. 8 is a flowchart of an example method for generating a trajectory pairing, according to some implementations of the present disclosure;

FIG. 9 is a flowchart of an example method for autonomous vehicle control, according to some implementations of the present disclosure;

FIG. 10 is a flowchart of an example method for determining a short-term trajectory to execute, according to some implementations of the present disclosure; and

FIG. 11 is a block diagram of an example computing system for trajectory selection, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

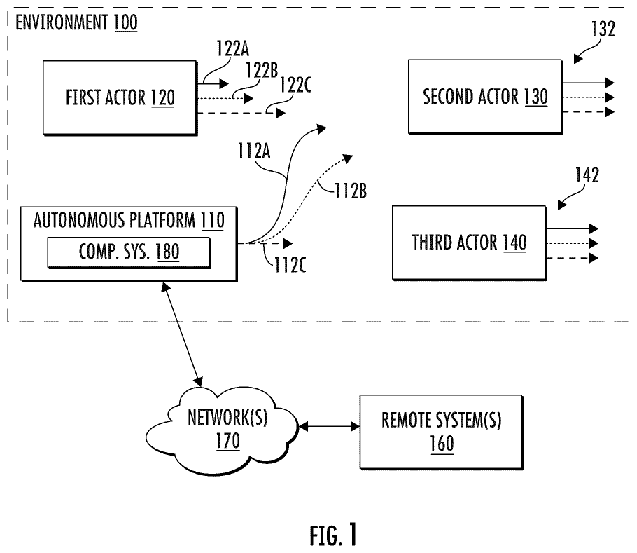

With reference to FIGS. 1-11, example implementations of the present disclosure are discussed in further detail. FIG. 1 is a block diagram of an example operational scenario, according to some implementations of the present disclosure. In the example operational scenario, an environment 100 contains an autonomous platform 110 and a number of objects, including first actor 120, second actor 130, and third actor 140. In the example operational scenario, the autonomous platform 110 can move through the environment 100 and interact with the object(s) that are located within the environment 100 (e.g., first actor 120, second actor 130, third actor 140, etc.). The autonomous platform 110 can optionally be configured to communicate with remote system(s) 160 through network(s) 170.

The environment 100 may be or include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, etc. The autonomous platform 110 may be an autonomous vehicle that can control, be connected to, or be otherwise associated with implements, attachments, and/or accessories for transporting people or cargo. This can include, for example, an autonomous tractor optionally coupled to a cargo trailer. Additionally, or alternatively, the autonomous platform 110 may be any other type of vehicle such as one or more aerial vehicles, water-based vehicles, space-based vehicles, other ground-based vehicles, etc.

The autonomous platform 110 may be configured to communicate with the remote system(s) 160. For instance, the remote system(s) 160 can communicate with the autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, the remote system(s) 160 can provide data indicating tasks that the autonomous platform 110 should perform. For example, as further described herein, the remote system(s) 160 can provide data indicating that the autonomous platform 110 is to perform a trip/service such as a user transportation trip/service, delivery trip/service (e.g., for cargo, freight, items), etc.

The autonomous platform 110 can communicate with the remote system(s) 160 using the network(s) 170. The network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, the network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from the autonomous platform 110.

As shown for example in FIG. 1, environment 100 can include one or more objects. The object(s) may be objects not in motion or not predicted to move (“static objects”) or object(s) in motion or predicted to be in motion (“dynamic objects” or “actors”). In some implementations, the environment 100 can include any number of actor(s) such as, for example, one or more pedestrians, animals, vehicles, etc. The actor(s) can move within the environment according to one or more actor trajectories. For instance, the first actor 120 can move along any one of the first actor trajectories 122A-C, the second actor 130 can move along any one of the second actor trajectories 132, the third actor 140 can move along any one of the third actor trajectories 142, etc.

As further described herein, the autonomous platform 110 can utilize its autonomy system(s) to detect these actors (and their movement) and plan its motion to navigate through the environment 100 according to one or more platform trajectories 112A-C. The autonomous platform 110 can include onboard computing system(s) 180. The onboard computing system(s) 180 can include one or more processors and one or more memory devices. The one or more memory devices can store instructions executable by the one or more processors to cause the one or more processors to perform operations or functions associated with the autonomous platform 110, including implementing its autonomy system(s).

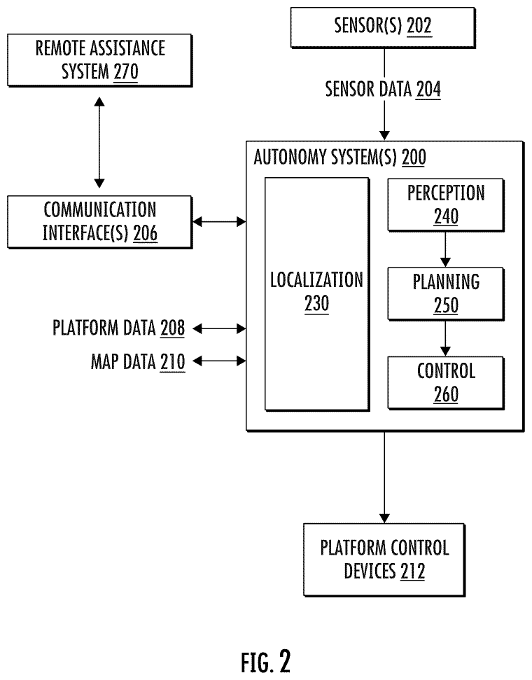

FIG. 2 is a block diagram of an example autonomy system 200 for an autonomous platform, according to some implementations of the present disclosure. In some implementations, the autonomy system 200 can be implemented by a computing system of the autonomous platform (e.g., the onboard computing system(s) 180 of the autonomous platform 110). The autonomy system 200 can operate to obtain inputs from sensor(s) 202 or other input devices. In some implementations, the autonomy system 200 can additionally obtain platform data 208 (e.g., map data 210) from local or remote storage. The autonomy system 200 can generate control outputs for controlling the autonomous platform (e.g., through platform control devices 212, etc.) based on sensor data 204, map data 210, or other data. The autonomy system 200 may include different subsystems for performing various autonomy operations. The subsystems may include a localization system 230, a perception system 240, a planning system 250, and a control system 260. The localization system 230 can determine the location of the autonomous platform within its environment; the perception system 240 can detect, classify, and track objects and actors in the environment; the planning system 250 can determine a trajectory for the autonomous platform; and the control system 260 can translate the trajectory into vehicle controls for controlling the autonomous platform. The autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the autonomy system 200 can be shared among its subsystems, or a subsystem can have a set of dedicated computing resources.

In some implementations, the autonomy system 200 can be implemented for or by an autonomous vehicle (e.g., a ground-based autonomous vehicle). The autonomy system 200 can perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing the autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

Autonomy system 200 can be located onboard (e.g., on or within) an autonomous platform and can be configured to operate the autonomous platform in various environments. The environment may be a real-world environment or a simulated environment. In some implementations, one or more simulation computing devices can simulate one or more of: the sensors 202, the sensor data 204, communication interface(s) 206, the platform data 208, or the platform control devices 212 for simulating operation of the autonomy system 200.

In some implementations, the autonomy system 200 can communicate with one or more networks or other systems with the communication interface(s) 206. The communication interface(s) 206 can include any suitable components for interfacing with one or more network(s) (e.g., the network(s) 170 of FIG. 1, etc.), including, for example, transmitters, receivers, ports, controllers, antennas, or other suitable components that can help facilitate communication. In some implementations, the communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, the autonomy system 200 can use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 can be supplemented or substituted by a remote system communicating over the communication interface(s) 206. For instance, in some implementations, the map data 210 can be downloaded over a network to a remote system using the communication interface(s) 206. In some examples, one or more of the localization system 230, the perception system 240, the planning system 250, or the control system 260 can be updated, influenced, nudged, communicated with, etc. by a remote system for assistance, maintenance, situational response override, management, etc.

The sensor(s) 202 can be located onboard the autonomous platform. In some implementations, the sensor(s) 202 can include one or more types of sensor(s). For instance, one or more sensors can include image capturing device(s) (e.g., visible spectrum cameras, infrared cameras, etc.). Additionally, or alternatively, the sensor(s) 202 can include one or more depth capturing device(s). For example, the sensor(s) 202 can include one or more Light Detection and Ranging (LIDAR) sensor(s) or Radio Detection and Ranging (RADAR) sensor(s). The sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 202 for capturing depth information can be fixed to a rotational device in order to rotate the sensor(s) 202 about an axis. The sensor(s) 202 can be rotated about the axis while capturing data in interval sector packets descriptive of different portions of a three-hundred-and-sixty-degree view of a surrounding environment of the autonomous platform. In some implementations, one or more of the sensor(s) 202 for capturing depth information can be solid state.

The sensor(s) 202 can be configured to capture the sensor data 204 indicating or otherwise being associated with at least a portion of the environment of the autonomous platform. The sensor data 204 can include image data (e.g., 2D camera data, video data, etc.), RADAR data, LIDAR data (e.g., 3D point cloud data, etc.), audio data, or other types of data. In some implementations, the autonomy system 200 can obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 can obtain sensor data 204 associated with particular component(s) or system(s) of an autonomous platform. This sensor data 204 can indicate, for example, wheel speed, component temperatures, steering angle, cargo or passenger status, etc. In some implementations, the autonomy system 200 can obtain sensor data 204 associated with ambient conditions, such as environmental or weather conditions. In some implementations, the sensor data 204 can include multi-modal sensor data. The multi-modal sensor data can be obtained by at least two different types of sensor(s) (e.g., of the sensors 202) and can indicate static object(s) or actor(s) within an environment of the autonomous platform. The multi-modal sensor data can include at least two types of sensor data (e.g., camera and LIDAR data). In some implementations, the autonomous platform can utilize the sensor data 204 for sensors that are remote from (e.g., offboard) the autonomous platform. This can include for example, sensor data 204 captured by a different autonomous platform.

The autonomy system 200 can obtain the map data 210 associated with an environment in which the autonomous platform was, is, or will be located. The map data 210 can provide information about an environment or a geographic area. For example, the map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, the map data 210 can include high-definition map information. Additionally, or alternatively, the map data 210 can include sparse map data (e.g., lane graphs, etc.). In some implementations, the sensor data 204 can be fused with or used to update the map data 210 in real-time.

The autonomy system 200 can include the localization system 230, which can provide an autonomous platform with an understanding of its location and orientation in an environment. In some examples, the localization system 230 can support one or more other subsystems of the autonomy system 200, such as by providing a unified local reference frame for performing, e.g., perception operations, planning operations, or control operations.

In some implementations, the localization system 230 can determine a current position of the autonomous platform. A current position can include a global position (e.g., respecting a georeferenced anchor, etc.) or relative position (e.g., respecting objects in the environment, etc.). The localization system 230 can generally include or interface with any device or circuitry for analyzing a position or change in position of an autonomous platform (e.g., autonomous ground-based vehicle, etc.). For example, the localization system 230 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of the autonomy system 200 or provided to a remote computing system (e.g., using the communication interface(s) 206).

In some implementations, the localization system 230 can register relative positions of elements of a surrounding environment of an autonomous platform with recorded positions in the map data 210. For instance, the localization system 230 can process the sensor data 204 (e.g., LIDAR data, RADAR data, camera data, etc.) for aligning or otherwise registering to a map of the surrounding environment (e.g., from the map data 210) to understand the autonomous platform's position within that environment. Accordingly, in some implementations, the autonomous platform can identify its position within the surrounding environment (e.g., across six axes, etc.) based on a search over the map data 210. In some implementations, given an initial location, the localization system 230 can update the autonomous platform's location with incremental re-alignment based on recorded or estimated deviations from the initial location. In some implementations, a position can be registered directly within the map data 210.

In some implementations, the map data 210 can include a large volume of data subdivided into geographic tiles, such that a desired region of a map stored in the map data 210 can be reconstructed from one or more tiles. For instance, a plurality of tiles selected from the map data 210 can be stitched together by the autonomy system 200 based on a position obtained by the localization system 230 (e.g., a number of tiles selected in the vicinity of the position).

In some implementations, the localization system 230 can determine positions (e.g., relative, or absolute) of one or more attachments or accessories for an autonomous platform. For instance, an autonomous platform can be associated with a cargo platform, and the localization system 230 can provide positions of one or more points on the cargo platform. For example, a cargo platform can include a trailer or other device towed or otherwise attached to or manipulated by an autonomous platform, and the localization system 230 can provide for data describing the position (e.g., absolute, relative, etc.) of the autonomous platform as well as the cargo platform. Such information can be obtained by the other autonomy systems to help operate the autonomous platform.

The autonomy system 200 can include the perception system 240, which can allow an autonomous platform to detect, classify, and track objects and actors in its environment. Environmental features or objects perceived within an environment can be those within the field of view of the sensor(s) 202 or predicted to be occluded from the sensor(s) 202. This can include object(s) not in motion or not predicted to move (static objects) or object(s) in motion or predicted to be in motion (dynamic objects/actors).

The perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 240 can determine the state(s) using one or more algorithms or machine-learned models configured to identify/classify objects based on inputs from the sensor(s) 202. The perception system can use different modalities of the sensor data 204 to generate a representation of the environment to be processed by the one or more algorithms or machine-learned models. In some implementations, state(s) for one or more identified or unidentified objects can be maintained and updated over time as the autonomous platform continues to perceive or interact with the objects (e.g., maneuver with or around, yield to, etc.). In this manner, the perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

The autonomy system 200 can include the planning system 250, which can be configured to determine how the autonomous platform is to interact with and move within its environment. The planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of the planning system 250. A motion trajectory can be defined by one or more waypoints (with associated coordinates). The waypoint(s) can be future location(s) for the autonomous platform. The motion plans can be continuously generated, updated, and considered by the planning system 250.

The motion planning system 250 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 250 can determine a desired trajectory for executing a strategy. For instance, the planning system 250 can obtain one or more trajectories for executing one or more strategies. The planning system 250 can evaluate trajectories or strategies (e.g., with scores, costs, rewards, constraints, etc.) and rank them. For instance, the planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 250 can utilize static cost(s) to evaluate trajectories for the autonomous platform (e.g., “avoid lane boundaries,” “minimize jerk,” etc.). Additionally, or alternatively, the planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 250 can rank trajectories based on one or more static costs, one or more dynamic costs, or a combination thereof. The planning system 250 can select a motion plan (and a corresponding trajectory) based on a ranking of a plurality of candidate trajectories. In some implementations, the planning system 250 can select a highest ranked candidate, or a highest ranked feasible candidate.

The planning system 250 can then validate the selected trajectory against one or more constraints before the trajectory is executed by the autonomous platform.

To help with its motion planning decisions, the planning system 250 can be configured to perform a forecasting function. The planning system 250 can forecast future state(s) of the environment. This can include forecasting the future state(s) of other actors in the environment. In some implementations, the planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally, or alternatively, the probabilities can include probabilities conditioned on trajectory options available to one or more other actors.

In some implementations, the planning system 250 can perform interactive forecasting. The planning system 250 can determine a motion plan for an autonomous platform with an understanding of how forecasted future states of the environment can be affected by execution of one or more candidate motion plans.

By way of example, with reference again to FIG. 1, the autonomous platform 110 can determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). The autonomous platform 110 can evaluate each of the potential platform trajectories and predict its impact on the environment.

For example, the autonomous platform 110 (e.g., using its autonomy system 200) can determine that a platform trajectory 112A would move the autonomous platform 110 more quickly into the area in front of the first actor 120 and is likely to cause the first actor 120 to decrease its forward speed and yield more quickly to the autonomous platform 110 in accordance with a first actor trajectory 122A.

Additionally or alternatively, the autonomous platform 110 can determine that a platform trajectory 112B would move the autonomous platform 110 gently into the area in front of the first actor 120 and, thus, may cause the first actor 120 to slightly decrease its speed and yield slowly to the autonomous platform 110 in accordance with a first actor trajectory 122B.

Additionally or alternatively, the autonomous platform 110 can determine that a platform trajectory 112C would cause the autonomous vehicle to remain in a parallel alignment with the first actor 120 and, thus, the first actor 120 is unlikely to yield any distance to the autonomous platform 110 in accordance with first actor trajectory 122C.

Based on comparison of the forecasted scenarios to a set of desired outcomes (e.g., by scoring scenarios based on a cost or reward), the planning system 250 can select a motion plan (and its associated trajectory) in view of the autonomous platform's interaction with the environment 100. In this manner, for example, the autonomous platform 110 can interleave its forecasting and motion planning functionality.

To implement selected motion plans, the autonomy system 200 can include a control system 260 (e.g., a vehicle control system). Generally, the control system 260 can provide an interface between the autonomy system 200 and the platform control devices 212 for implementing the strategies and motion plan(s) generated by the planning system 250. For instance, control system 260 can implement the selected motion plan/trajectory to control the autonomous platform's motion through its environment by following the selected trajectory (e.g., the waypoints included therein). The control system 260 can, for example, translate a motion plan into instructions for the appropriate platform control devices 212 (e.g., acceleration control, brake control, steering control, etc.). By way of example, the control system 260 can translate a selected motion plan into instructions to adjust a steering component (e.g., a steering angle) by a certain number of degrees, apply a certain magnitude of braking force, increase/decrease speed, etc. In some implementations, the control system 260 can communicate with the platform control devices 212 through communication channels including, for example, one or more data buses (e.g., controller area network (CAN), etc.), onboard diagnostics connectors (e.g., OBD-II, etc.), or a combination of wired or wireless communication links. The platform control devices 212 can send or obtain data, messages, signals, etc. to or from the autonomy system 200 (or vice versa) through the communication channel(s).

The autonomy system 200 can receive, through communication interface(s) 206, assistive signal(s) from remote assistance system 270. Remote assistance system 270 can communicate with the autonomy system 200 over a network (e.g., as a remote system 160 over network 170). In some implementations, the autonomy system 200 can initiate a communication session with the remote assistance system 270. For example, the autonomy system 200 can initiate a session based on or in response to a trigger. In some implementations, the trigger may be an alert, an error signal, a map feature, a request, a location, a traffic condition, a road condition, etc.

After initiating the session, the autonomy system 200 can provide context data to the remote assistance system 270. The context data may include sensor data 204 and state data of the autonomous platform. For example, the context data may include a live camera feed from a camera of the autonomous platform and the autonomous platform's current speed. An operator (e.g., human operator) of the remote assistance system 270 can use the context data to select assistive signals. The assistive signal(s) can provide values or adjustments for various operational parameters or characteristics for the autonomy system 200. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the autonomy system 200.

Autonomy system 200 can use the assistive signal(s) for input into one or more autonomy subsystems for performing autonomy functions. For instance, the planning subsystem 250 can receive the assistive signal(s) as an input for generating a motion plan. For example, assistive signal(s) can include constraints for generating a motion plan. Additionally, or alternatively, assistive signal(s) can include cost or reward adjustments for influencing motion planning by the planning subsystem 250. Additionally, or alternatively, assistive signal(s) can be considered by the autonomy system 200 as suggestive inputs for consideration in addition to other received data (e.g., sensor inputs, etc.).

The autonomy system 200 may be platform agnostic, and the control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

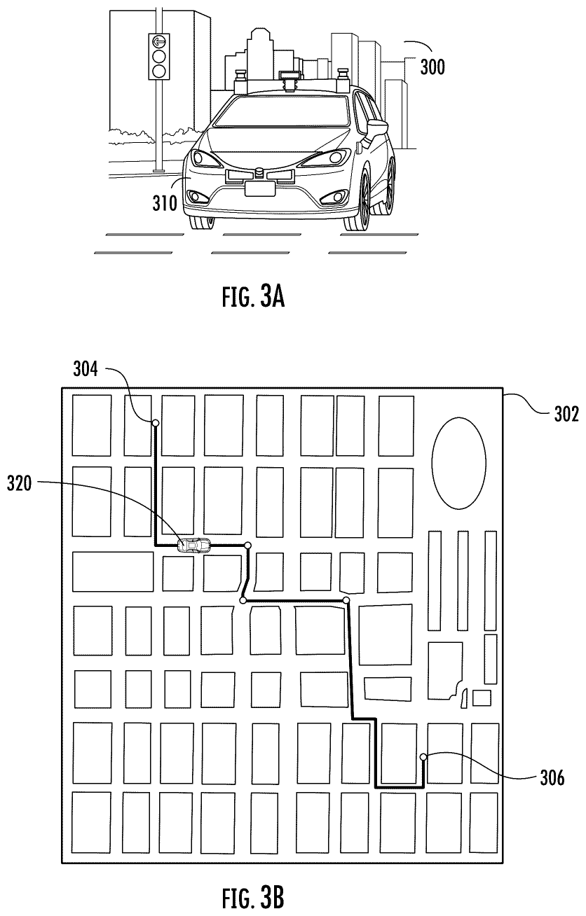

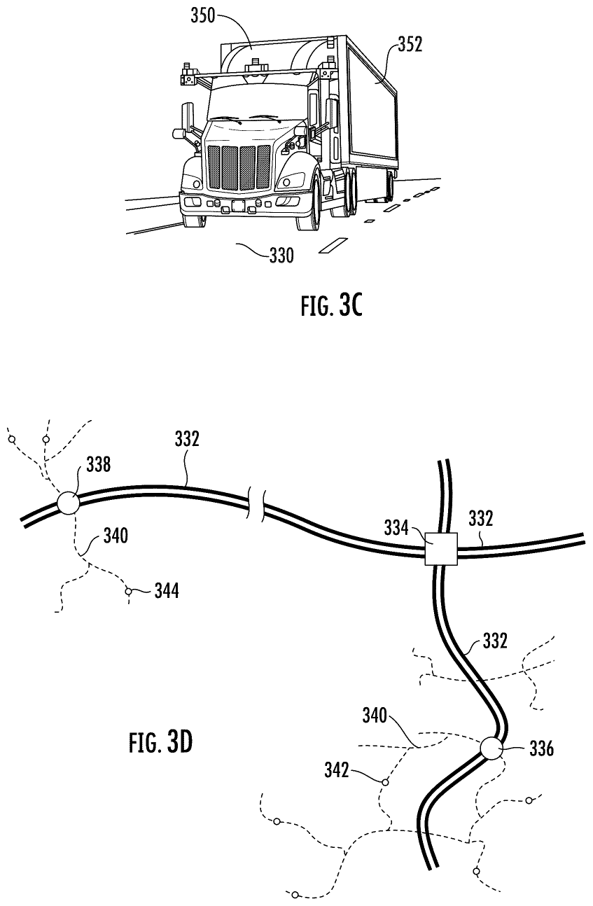

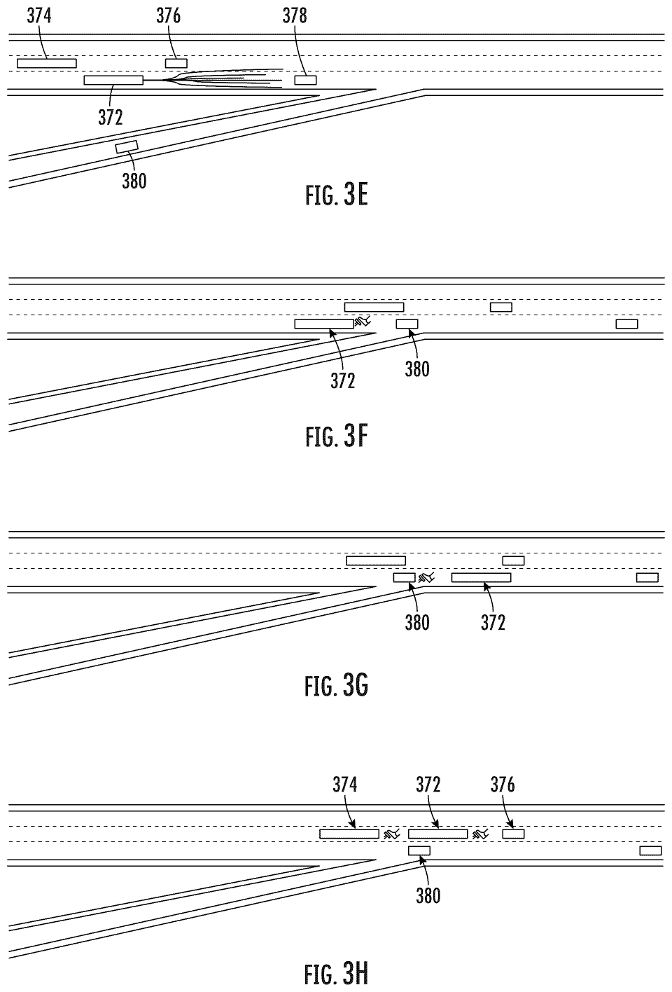

For example, with reference to FIG. 3A, an operational environment can include a dense environment 300. An autonomous platform can include an autonomous vehicle 310 controlled by the autonomy system 200. In some implementations, the autonomous vehicle 310 can be configured for maneuverability in a dense environment, such as with a configured wheelbase or other specifications. In some implementations, the autonomous vehicle 310 can be configured for transporting cargo or passengers. In some implementations, the autonomous vehicle 310 can be configured to transport numerous passengers (e.g., a passenger van, a shuttle, a bus, etc.). In some implementations, the autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of the dense environment 300 is shown overlaid with an example trip/service between a first location 304 and a second location 306. The example trip/service can be assigned, for example, to an autonomous vehicle 320 by a remote computing system. The autonomous vehicle 320 can be, for example, the same type of vehicle as autonomous vehicle 310. The example trip/service can include transporting passengers or cargo between the first location 304 and the second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by the autonomy system 200. This can include an autonomous tractor for an autonomous truck. In some implementations, the autonomous vehicle 350 can be configured for high payload transport (e.g., transporting freight or other cargo or passengers in quantity), such as for long distance, high payload transport. For instance, the autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) the autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) can be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service can be assigned by a remote computing system. In some implementations, the transfer hub 336 can be an origin point for cargo (e.g., a depot, a warehouse, a facility, etc.) and the transfer hub 338 can be a destination point for cargo (e.g., a retailer, etc.). However, in some implementations, the transfer hub 336 can be an intermediate point along a cargo item's ultimate journey between its respective origin and its respective destination. For instance, a cargo item's origin can be situated along the access travel ways 340 at the location 342. The cargo item can accordingly be transported to transfer hub 336 (e.g., by a human-driven vehicle, by the autonomous vehicle 310, etc.) for staging. At the transfer hub 336, various cargo items can be grouped or staged for longer distance transport over the travel ways 332.

In some implementations of an example trip/service, a group of staged cargo items can be loaded onto an autonomous vehicle (e.g., the autonomous vehicle 350) for transport to one or more other transfer hubs, such as the transfer hub 338. For instance, although not depicted, it is to be understood that the open travel way environment 330 can include more transfer hubs than the transfer hubs 336 and 338 and can include more travel ways 332 interconnected by more interchanges 334. A simplified map is presented here for purposes of clarity only. In some implementations, one or more cargo items transported to the transfer hub 338 can be distributed to one or more local destinations (e.g., by a human-driven vehicle, by the autonomous vehicle 310, etc.), such as along the access travel ways 340 to the location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

To improve the performance of an autonomous platform, such as an autonomous vehicle controlled at least in part using autonomy system 200 (e.g., the autonomous vehicles 310 or 350), the planning system 250 can implement trajectory generation and selection techniques according to example aspects of the present disclosure.

FIG. 3E is an illustration of example trajectories for an autonomous vehicle in an environment, according to some implementations of the present disclosure. The example environment of FIGS. 3E-3H include an autonomous vehicle 372, a first vehicle 374, a second vehicle 376, a third vehicle 378, and a merging vehicle 380. FIG. 3E depicts a plurality of candidate trajectories that may be executed by the autonomous vehicle 372. In FIG. 3E, the merging vehicle 380 is on the on-ramp to merge onto the multi-lane interstate currently inhabited by the autonomous vehicle 372, the first vehicle 374, the second vehicle 376, and the third vehicle 378. FIGS. 3F-3H depict example actions that can be performed by the autonomous vehicle 372 based on the merging vehicle 380.

FIG. 3F illustrates an outcome resulting from the autonomous vehicle 372 executing a first trajectory, according to some implementations of the present disclosure. Specifically, FIG. 3F depicts the autonomous vehicle 372 staying in the right-hand lane and allowing the merging vehicle 380 to merge in front.

FIG. 3G illustrates an outcome resulting from the autonomous vehicle 372 executing a second trajectory, according to some implementations of the present disclosure. Specifically, FIG. 3G depicts the autonomous vehicle 372 staying in the current lane and allowing the merging vehicle 380 to merge behind.

FIG. 3H illustrates an outcome resulting from autonomous vehicle 372 executing a third trajectory, according to some implementations of the present disclosure. Specifically, FIG. 3H depicts the autonomous vehicle 372 merging into the lane of the first vehicle 374 and the second vehicle 376.

The first, second, and third trajectories can have differing strategic costs that can be determined and evaluated to determine which trajectory to select.

According to the present technology, the evaluation of the strategic cost can include determining a plurality of short-term trajectories and a plurality of long-term trajectories. The plurality of short-term trajectories and the plurality of long-term trajectories can be processed to generate a plurality of trajectory pairings. As will be further described herein, cost data can be determined based on the trajectory pairings, which can then be utilized to select a trajectory based on both immediate cost evaluations and long-term forecasts.

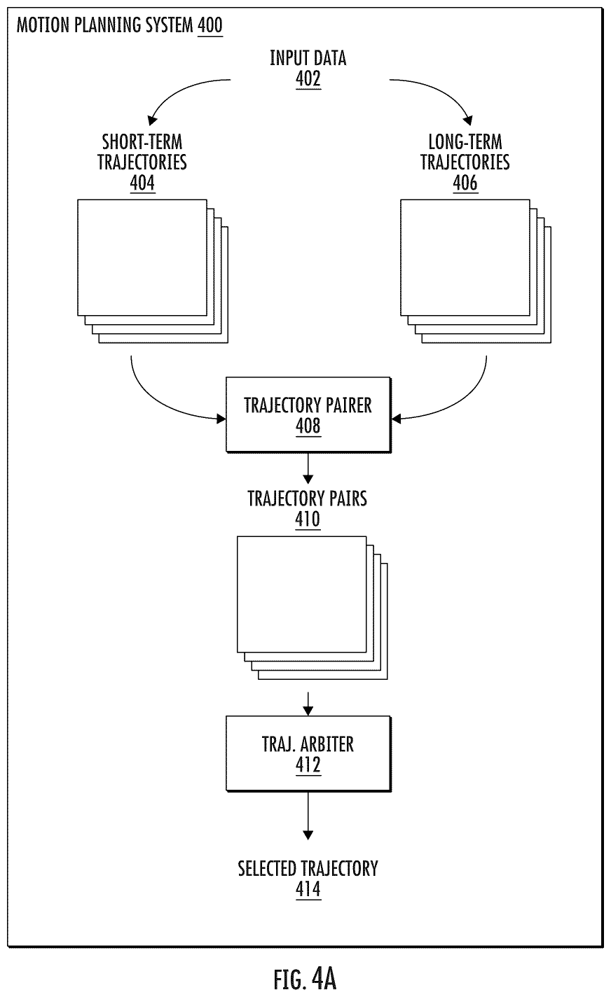

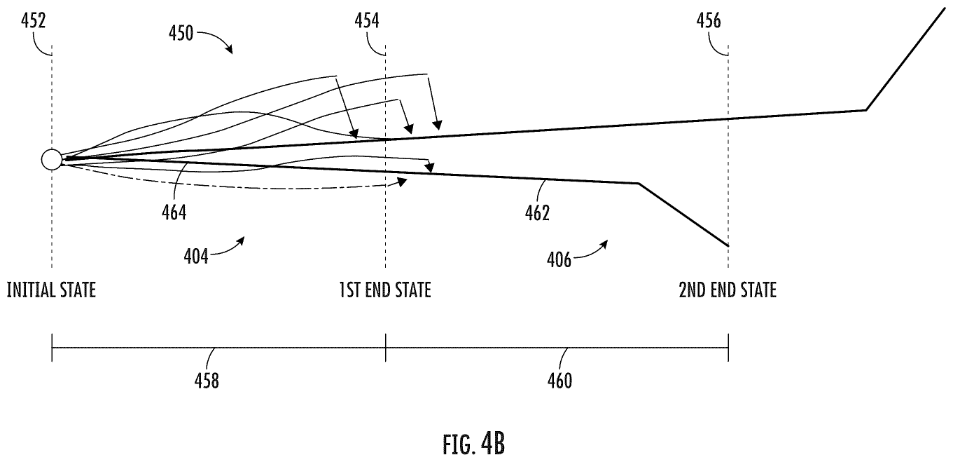

FIG. 4A is a block diagram of a system for long-horizon-based motion planning, according to some implementations of the present disclosure. The motion planning system 400 can process input data 402 to determine a trajectory to execute for the autonomous vehicle. The motion planning system 400 can include one or more machine-learned models, one or more deterministic functions, and/or may leverage heuristics in determining the trajectory to execute.

The input data 402 can include sensor data descriptive of an environment of an autonomous vehicle. This can include, for example, sensor data 402. The sensor data can include camera data, radar data, LIDAR data, and/or other sensor data. The input data 402 can indicate one or more objects that are perceived within the environment of the autonomous vehicle. Additionally or alternatively, the input data 402 can include data descriptive of a strategy, end goal, current/forecasted object trajectory or path, current vehicle trajectory or other vehicle dynamics, or other input data.

The motion planning system 400 can process the input data 402 to determine a plurality of short-term trajectories 404 and a plurality of long-term trajectories 406. The motion planning system 400 can determine the plurality of short-term trajectories 404 and the plurality of long-term trajectories 406 separately. In some implementations, the motion planning system 400 can determine the plurality of short-term trajectories 404 and the plurality of long-term trajectories 406 in parallel.

With reference to FIG. 4B, the plurality of short-term trajectories 404 can be descriptive of candidate motion paths from an initial state 452 to a first end state 454. The initial state 452 can be descriptive of where the autonomous vehicle is currently (e.g., t0). The first end state 454 can be descriptive of a location of the autonomous vehicle after a first amount of time has elapsed (e.g., t0+Xs, where X=5 s, etc.).

The plurality of long-term trajectories 406 can be descriptive of candidate motion paths from an initial state 542 to a second end state 546. The time span from the initial state 542 to the second end state 546 can be longer than the time span from the initial state 542 to the first end state 544. The second end state 546 can be descriptive of a location of the autonomous vehicle after a second amount of time has elapsed (e.g., t0+Ys, where Y=25 s, etc.).

Returning to FIG. 4A, the motion planning system 400 can determine the plurality of short-term trajectories 404 and the plurality of long-term trajectories 406 by querying a trajectory library (e.g., stored trajectories output from a proposer) based on the input data 402. This may include the use of machine-learned models, deterministic functions, etc.

A trajectory pairer 408 of the motion planning system 400 can process the plurality of short-term trajectories 404 and the plurality of long-term trajectories 406 to generate a plurality of trajectory pairs 410. The motion planning system 400 can generate the plurality of trajectory pairs 410 by determining that a particular short-term trajectory of the plurality of short-term trajectories 404 is associated with a particular long-term trajectory of the plurality of long-term trajectories 406. The association can be based on an end point of the particular short-term trajectory being proximate to a waypoint of the particular long-term trajectory. Additionally and/or alternatively, the motion planning system 400 can determine the association based on context (e.g., the location of other vehicles in the environment, speed of the autonomous vehicle, and/or trajectories of other vehicles), a cost evaluation (e.g., a resource cost of the deviation from the end state of the particular short-term trajectory to the path of the particular long-term trajectory), and/or a determined overlap.

With reference again to FIG. 4B, the plurality of trajectory pairs 410 can be descriptive of a hybrid trajectory. The hybrid trajectory can include a first portion 458 that includes a respective short-term trajectory 404 and a second portion 460 descriptive of a second segment 462 of the respective long-term trajectory 406. The second segment 462 of the long-term trajectory 406 can be the segment of the trajectory from the time point of the first end state 454 to the time point of the second end state 456. A first segment 464 of the long-term trajectory 406 can be the segment of the trajectory from the time point of the initial state 452 to the time point of the first end state 454.

Returning to FIG. 4A, the trajectory pairer 408 can perform trajectory smoothing to provide a transition between the short-term trajectory 404 and the long-term trajectory 406 by generating a trajectory transition, by including more of the long-term trajectory, and/or by taking less of the short-term trajectory and less of the long-term trajectory and generating a path trajectory that bridges the transition deviation. In some implementations, a subset of the plurality of trajectory pairs 410 may be associated with a given short-term trajectory 404 (and/or vice versa), such that a branching trajectory representation can be generated for the given short-term trajectory 404.

A trajectory arbiter 412 can process the plurality of trajectory pairs 410 to determine a selected trajectory 414. The trajectory arbiter 412 can obtain and/or generate cost data for each of the plurality of trajectory pairs 410. The cost data can be descriptive of resources that would be utilized for the candidate motion path and/or may be descriptive of potential interactions with the environment for the candidate motion path. In some implementations, trajectory pairs associated with the same short-term trajectory may be grouped. The trajectory arbiter 412 may determine the selected trajectory 414 based on the plurality of cost datasets associated with the plurality of trajectory pairs 410. The cost data for trajectory pairs associated with the same short-term trajectory may be aggregated and/or averaged.

Alternatively or additionally, the trajectory arbiter 412 can rank the candidate trajectories according to one or more costs associated with the respective trajectory pairs 410. In some cases, the trajectory arbiter 412 may include one or more machine-learned models trained on expert human driving data. The one or more machined-learned models may be trained to determine a cost corresponding to a difference between a respective trajectory and a human driver's strategy in the same driving scenario. In some implementations, the trajectory arbiter 412 may consider the forecasted goal(s) and/or forecasted interaction(s) predicted for the actors within the environment when ranking the candidate trajectories.

The trajectory arbiter 412 can identify an optimal trajectory based on the contextual data and one or more cost functions. The cost functions, for example, can include static cost functions that encode one or more desired driving behaviors such as, for example, avoiding lane boundaries, remaining near the center of a lane, avoiding acceleration and/or jerk, avoiding steering jerk, etc. In addition, or alternatively, the cost functions can include dynamic cost functions that can evaluate dynamic constraints. The dynamic cost functions, for example, can evaluate the forecasted goal(s), the forecasted interaction(s), and/or the continuous trajectories predicted for the actors within the environment.

The trajectory arbiter 412 can select a short-term strategy for implementation by the autonomous platform. To do so, the trajectory arbiter 412 can reject one or more trajectories that result in interference with other actors/objects, violate lane boundaries, etc. The trajectory arbiter 412 can select the optimal trajectory and strategy pair from the non-rejected trajectories that optimizes (e.g., minimizes) the aggregate cost as evaluated by the static and/or dynamic cost functions described herein. In some implementations, the trajectory arbiter 412 can select the selected strategy 414 based on the forecasted goal(s) for the actors within the environment.

The selected trajectory 414 can be a short-term trajectory to be executed by the autonomous vehicle. The selected trajectory 414 may be determined based on a particular trajectory pair and/or based on a group of trajectory pairs associated with a particular short-term trajectory.

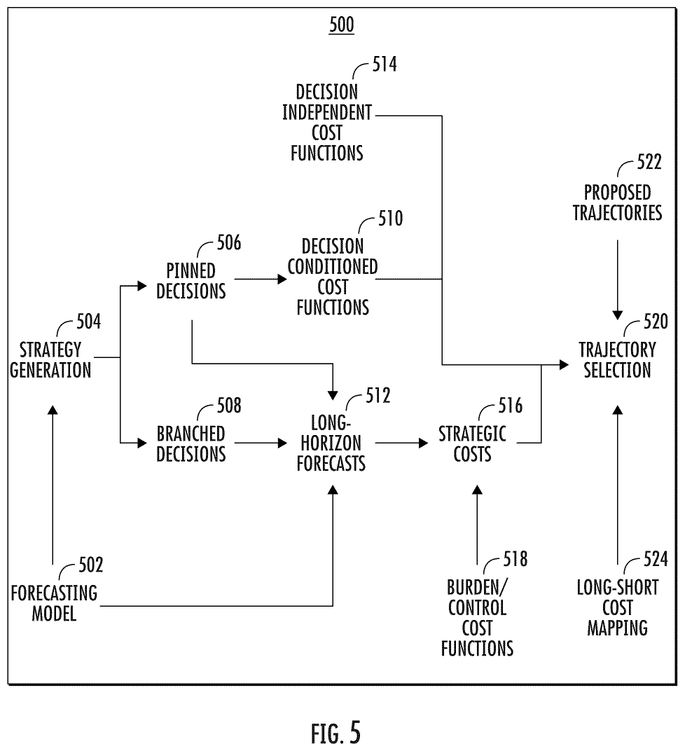

FIG. 5 is a block diagram of an example computing system 500 for trajectory selection, according to some implementations of the present disclosure. The system 500 can be a vehicle computing system onboard the autonomous vehicle, or a subsystem thereof (e.g., motion planning system 400). The system can include a forecasting model 502. The forecasting model 502 may process sensor data and map data to generate forecasts for one or more actors in the environment of the autonomous vehicle. A forecast for a respective actor may be a probability distribution over goal locations or trajectories for the actor. A strategy generation block 504 can process the forecasts to generate one or more candidate strategies, each candidate strategy comprising one or decisions. The one or more candidate strategies may have pinned decisions 506 and/or branched decisions 508. Pinned decisions 506 are deterministic decisions that are common to all particular candidate strategies. Pinned decisions 506 can include high confidence decisions that the system is not considering alternatives for based on the high level of confidence.

Branched decisions 508 are decisions that are not common to all candidate strategies, such that at least two strategies have a different decision value for a particular decision with respect to an actor in the environment. Branched decisions 508 may not be explicitly enumerated. Rather, the system 500 may be less constrained with respect to that strategic option.

The system 500 can process the pinned decisions 506 and/or the branched decisions 508 to sample one or more long-horizon forecasts 512 associated with the determined intent. In some implementations, the pinned decisions 506 and/or the branched decisions 508 may be interconnected, interdependent, and/or performed together.

In some implementations, the long-horizon forecasts 512 are associated with a search space that is bounded by the pinned decisions 506. For example, the system 500 can process the pinned decisions 506 with one or more decision conditioned cost functions 510 to determine one or more decision condition cost values (e.g., a different cost determination may be performed if the autonomous vehicle merges behind another vehicle than if the autonomous vehicle remains in the current lane). In some implementations, the one or more decision conditioned cost functions 510 can be dependent on and/or utilize the branched decisions 508. The system 500 can leverage the one or more decision conditioned cost functions 510 to evaluate a plurality of different costs of performing the particular decision, which can include hard braking, heavy acceleration, side-to-side movement, proximity to a shoulder, proximity to a barrier, a distance to goal change, and/or other potential costs stemming from the autonomous vehicle performing that decision. The one or more decision condition cost values can include an aggregated total and/or may include a plurality of values associated with a plurality of different cost metrics associated with changes caused by actions performed by the autonomous vehicle.

Additionally and/or alternatively, the system 500 can utilize one or more decision independent cost functions 514 to determine one or more decision independent cost values. The system 500 can leverage the one or more decision independent cost functions 514 to evaluate a plurality of different costs that are independent of the decision selected. The one or more decision independent cost functions 514 can evaluate cost associated with other actors in the environment (e.g., other vehicles, pedestrians, and/or animals), the static objects in the environment, the weather, and/or other factors that would affect the cost of traversing the environment regardless of the decision performed. The one or more decision independent cost values can include an aggregated total and/or may include a plurality of values associated with a plurality of different cost metrics associated with travel cost constants.

Moreover, a strategic costs block 516 can process the one or more long-horizon forecasts 512 to determine one or more long-horizon cost values. The one or more long-horizon forecasts 512 may correspond to long-horizon trajectories. For example, the strategic costs block 516 can determine costs associated with different long-term trajectories such as high-cost lane changes (e.g., rapid acceleration to enter lane). The strategic costs block 516 can determine costs associated with low-cost coasting, and/or potential high-cost interactions (e.g., braking by both the autonomous vehicle and another vehicle).

In some implementations, the strategic costs block 516 performs the cost determinations based on one or more burden/control cost functions 518. The strategic costs block 516 and the one or more burden/control cost functions 518 can be integrated or operate as an integral block to the system 500. For example, the strategic cost block can leverage the one or more burden/control cost functions 518 to determine a burden cost for an acceleration and/or resource utilization cost of performing one or more control actions (e.g., turning and/or braking). This may include, for example, the cost of a burden to other actors-what it would take for other actors to respond (e.g., to a lane change maneuver). In some implementations, the system can feed the one or more long-horizon forecasts 512 into the one or more burden/control cost functions 518. The system may aggregate the one or more decision condition cost values, the one or more decision independent cost values, and the one or more long-horizon cost values to generate a cost dataset that may then be utilized to perform trajectory selection 520. Trajectory selection 520 can include selecting a candidate trajectory from a plurality of proposed trajectories 522 based on the decision independent cost functions 514, the decision conditioned cost functions 510, the strategic cost datasets, and/or long-short cost mapping 524. For example, the system 500 can determine a plurality of candidate trajectories to generate the plurality of proposed trajectories 522. The system can determine the proposed trajectories 522 based on an intent (e.g., an intent determined based on the intent model 502). In some implementations, the system 500 can determine and compare cost data for the strategies and/or the trajectories to determine strategies and/or trajectories that are more effective, more efficient, timelier, and/or more direct. The selection may be based on weighted averages of the cost values and/or based on cost value aggregation.

The system 500 can utilize the decision independent cost functions 514 and the decision conditioned cost functions 510 to determine one or more cost values for each of the pinned decisions 506. In some implementations, the system 500 can provide the decision independent cost functions 514 with outputs of the forecasting model 502 to perform one or more computations, and/or the forecasting model 502 and the decision independent cost functions 514 may be integrated within a singular block. The system 500 can utilize the strategic costs block 516 to determine one or more cost values for each of the short-term trajectories and each of the long-term trajectories. The system 500 can then perform long-short cost mapping 524 to map (and/or determine) aggregate costs for trajectory pairs, which the system 500 can leverage to perform trajectory selection 500 that factors in both short-term and long-term costs.

FIG. 5 depicts the system 500 as having a plurality of different distinct blocks with particular relationships and dependencies; however the configuration of the system 500 may not be limited to the depicted configurations as different depicted blocks may be integrated as a singular block and/or may have dependencies not depicted in FIG. 5. For example, the strategic costs block 516 and the one or more burden/control cost functions 518 may be integrated into a combined processing block. The forecasting model 502 may feed into the decision independent cost functions 514. FIG. 5 depicts one of many possible configurations for the system 500. The various blocks can be implemented separately as illustrated or can be variously integrated with each other.

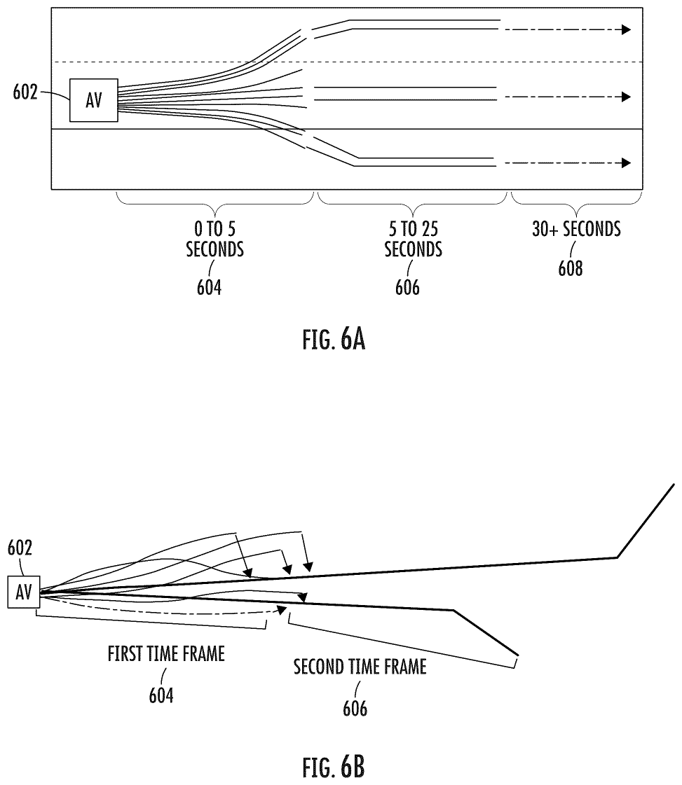

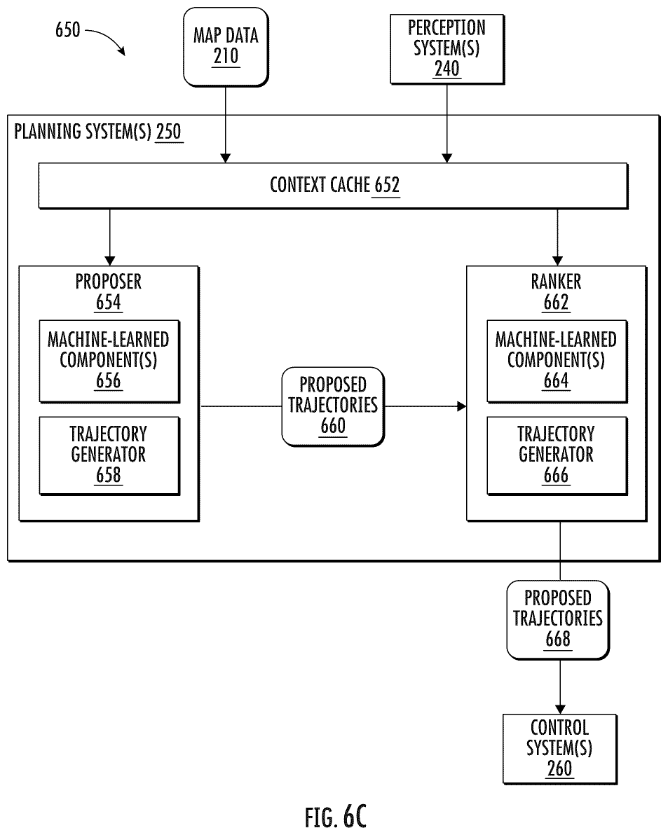

FIG. 6A is an illustration of example trajectory paths, according to some implementations of the present disclosure. In particular, FIG. 6A shows an autonomous vehicle 602 with a plurality of candidate trajectories associated with a plurality of different candidate lanes for the autonomous vehicle to traverse an environment. The motion planning system (e.g., motion planning system 400) can determine a plurality of short-term trajectories (e.g., short-term trajectories 404) for a first time frame 604, a plurality of long-term trajectories (e.g., long-term trajectories 406) for the first time frame 604 and a second time frame 606, and/or a plurality of additional trajectories for the first time frame 604, the second time frame 606, and a third time frame 608.

The first time frame 604 can be associated with a time spanning from an initial time (e.g., zero seconds from sensor data collection) to a first time (e.g., five seconds from the initial time). The second time frame 606 can be associated with a time spanning from the first time to a second time (e.g., twenty-five seconds from the initial time). The third time frame 608 can be associated with a time spanning from the second time to a third time (e.g., thirty seconds or more from the initial time).

FIG. 6B is an illustration of example short-horizon costs and long-horizon costs, according to some implementations of the present disclosure. In particular, FIG. 6B depicts a plurality of short-term trajectories and a plurality of long-term trajectories for the autonomous vehicle 602. The plurality of short-term trajectories can be fine-grained candidate trajectories for the first time frame 604. The plurality of long-term trajectories can be course candidate trajectories spanning both the first time frame 604 and the second time frame 606. The short-term trajectories can be fined-grained, for example, in that they include a greater number or a higher frequency of waypoints than the coarser long-term trajectories, which may include fewer or less frequent waypoints.

The computing system can generate trajectory pairings by determining that a short-term trajectory is associated with a respective long-term trajectory and then generating a hybrid trajectory representation that includes the short-term trajectory for the first time frame 604 and the long-term trajectory for the second time frame 606. The computing system can evaluate the trajectory pairings based on the short-horizon cost associated with the short-term trajectory and the long-horizon cost associated with the long-term trajectory. The short-horizon cost can be associated with predicted effects within the first time frame 604 (e.g., within five seconds from the current time) if a particular trajectory is performed. The short-horizon cost can be associated with immediate changes in speed and/or direction that may be performed if a particular trajectory is selected. Additionally and/or alternatively, the short-horizon cost can be associated with immediate environmental relationship changes (e.g., proximity to other cars, location with relation to a turn lane or shoulder, and/or relationships with nature) that may occur if the particular trajectory is performed.

Long-horizon cost can be associated with predicted effects within the second time frame 606 (e.g., between five seconds and twenty-five seconds from the current time) if a particular trajectory is performed. The long-horizon cost can be associated with long-term changes (e.g., progressive changes and/or changes that may be predicted to occur upon a subsequent trajectory determination) in speed and/or direction that may be performed if a particular trajectory is selected. Additionally and/or alternatively, the long-horizon cost can be associated with environmental relationship changes (e.g., proximity to other cars, location with relation to a turn lane or shoulder, and/or relationships with nature) that may occur in the long-term if the particular trajectory is performed.

The computing system can then compare the cost datasets associated with a plurality of different trajectory pairings to determine a trajectory to execute to control the autonomous vehicle 602. For example, the computing system can determine a trajectory pair associated with a lowest aggregate cost that can then be selected. The computing system can then control the autonomous vehicle to execute the short-term trajectory for the selected trajectory pairing. In some implementations, the computing system may process trajectory pairs associated with the same short-term trajectory to generate a weighted and/or aggregate cost dataset for the particular short-term trajectory. The computing system may determine which short-term trajectory is associated with a lowest weighted (and/or aggregate) cost.

FIG. 6C is a block diagram of an example system 650 for motion planning, according to some implementations of the present disclosure. The planning system 250 can receive map data 210 and perception data from perception system 240 that describes an environment surrounding an autonomous vehicle. The planning system 250 can process the map data 210 and the perception data to populate a context cache 652 that can efficiently compile salient information for the planning task.

A proposer 654 can use one or more machine-learned components 656. The machine-learned components 656 can process data from the context cache 652 to generate an understanding of the environment. The proposer 654 can use a trajectory generator 658 that can generate proposed trajectories 660 that describe motion plans for the autonomous vehicle. The proposed trajectories 660 can include short-term trajectories and long-term trajectories.

A ranker 662 can rank proposed trajectories 660 using one or more machine-learned components 664 and a trajectory coster 666. For example, the machine-learned components 664 can process data from the context cache 652 to generate an understanding of the environment. The machine-learned components 664 can leverage upstream data from the proposer 654 to obtain a better understanding of the environment. The trajectory coster 666 can generate scores or costs for the proposed trajectories 660 in view of output from the machine-learned components 664. This can include performing costing operations for respective short-term and long-term trajectories, as described with reference to FIG. 5.

Based on the costs, the ranker 662 can output a selected trajectory 668. The selected trajectory 668 can have an optimal or preferred score based on a ranking of the proposed trajectories 660. The control system 260 can receive the selected trajectory 668 and control a motion of the autonomous vehicle based on the selected trajectory 668.

The context cache 652 can include data obtained directly from map data 210 or perception system 240. The context cache 652 can retrieve and organize data from the map data 210 and the perception system 240 in a manner configured for efficient processing by the proposer 654 and the ranker 662. For example, the context cache 652 can include a rolling buffer of information retrieved from the map data 210 or the perception system 240. For example, the context cache 652 can maintain a rolling buffer of map tiles or other map regions from the map data 210 based on a horizon or other threshold distance from the autonomous vehicle. The context cache 652 can maintain a buffer of nearby actors and their corresponding states and associated actor tracking data.

The context cache 652 can include data generated based on the map data 210 or the perception data from the perception system 240. For instance, the context cache 652 can include latent embeddings of the map data 210 or the perception data that encode an initial understanding of the scene surrounding the autonomous vehicle. The planning system 250 can perform preprocessing on the map data 210 to preprocess the map layout into streams. Streams can correspond to lanes or other nominal paths of traffic flow. The planning system 250 can associate traffic permissions to the streams. In this manner, for instance, the context cache 652 can include preprocessed data that encodes an initial understanding of the surrounding environment.

The planning system 250 can also perform other once-per-cycle preprocessing operations and store any results in the context cache 652 to reduce or eliminate redundant processing by the proposer 654 or the ranker 662.

The proposer 654 can be or include a model that ingests scene context (e.g., from the context cache 652) and outputs a plurality of candidate trajectories for the autonomous vehicle to consider following. The proposer 654 can include machine-learned components in the model. Machine-learned components can perform inference over inputs to generate outputs. For instance, machine-learned components can infer, based on patterns seen across many training examples, that a particular input maps to a particular output. The proposer 654 can include hand-tuned or engineered components. Engineered components can implement inductive or deductive operations. For instance, an engineered logic or rule can be deduced a priori from laws of physics, kinematics, known constraints, etc. The proposer 654 can include multiple different types of components to robustly achieve various performance and validation targets.

The machine-learned components 664 can include one or more machine-learned models or portions of a model (e.g., a layer of a model, an output head of a model, a branch of a model, etc.). One or more of the machine-learned components 664 can be configured to ingest data based on the context cache 652.

The machine-learned components 656 can be configured to perform various different operations. The machine-learned components 656 can perform scene understanding operations. For instance, one or more of the machine-learned components 656 can reason over a scene presented in the context cache 652 to form an understanding of relevant objects and actors to the planning task.

The machine-learned components 656 can perform forecasting operations. For instance, one or more of the machine-learned components 656 can generate forecasted movements for one or more actors in the environment (e.g., for actors determined to be relevant). The forecasts can include marginal forecasts of actor behavior.

Forecasts in the proposer 654 can be generated in various levels of detail. For instance, example forecasts for the proposer 654 can be one-dimensional. An example forecast for a respective actor can indicate an association between the actor and a stream or a particular location in a stream (e.g., a goal location). In the proposer 654, forecasting can include determining, using the machine-learned components 656, goals for one or more actors in a scene.

The machine-learned components 656 can perform decision-making operations. For instance, the planning system 250 can strategize about how to interact with and traverse the environment by considering its options for movement at the level of discrete decisions: for example, whether to yield or not yield to a merging actor. The machine-learned components 656 can use an understanding of the scene to evaluate, for a given decision (e.g., how to move with respect to a given actor), multiple different candidate decision values (e.g., yield to actor, or not yield to actor). A set of decision values for one or more discrete decisions can be referred to as a strategy. Different strategies can reflect different approaches for navigating the environment. The proposer 654 can pass strategy data to the ranker 662 to help rank the proposed trajectories 660.

The trajectory generator 658 can ingest data from the context cache 652 and output multiple candidate trajectories. The trajectory generator 658 can receive inputs from the machine-learned components 656. For instance, the trajectory generator 658 can receive inputs from one or more machine-learned models that can understand the scene context and bias generated trajectories toward a particular distribution (e.g., to avoid generating irrelevant or low-likelihood trajectories in the given context).

The trajectory generator 658 can operate independently of one or more of the machine-learned components 656. For instance, the trajectory generator 658 can operate independently of a forecasting model or a decision-making model or any forecasts or decisions.

The trajectory generator 658 can operate directly from the context cache 652. For example, the trajectory generator 658 can use map geometry (e.g., a lane spline) and initial state information (e.g., actor and autonomous vehicle state data from the context cache 652) to generate a range of nominally relevant trajectories that the autonomous vehicle could follow. The range can be constrained, such as by performance or comfort constraints on the autonomous vehicle capabilities (e.g., longitudinal or lateral acceleration limits) or external constraints (e.g., speed limit). The trajectory generator 658 can generate short-term and long-term trajectories.

The trajectory generator 658 can generate trajectories using sampling-based techniques. The trajectory generator 658 can determine a relevant range of a parameter associated with a trajectory (e.g., a speed, an acceleration, a steering angle, etc.) and generate a number of sampled values for that parameter within the range. The sampled values can be uniformly distributed, normally distributed, or adhere to some other prior distribution.

The trajectory generator 658 can use one or more of machine-learned components 656 to generate trajectories in a ranked order. For instance, the trajectory generator 658 can sample parameters or combinations of parameters with priority on parameters or combinations of parameters that are similar to human-driven exemplars. For example, a machine-learned component can cause the trajectory generator 658 to sample, with higher probability, parameters or combinations of parameters that are similar to human-driven exemplars. The machine-learned component can be trained using a corpus of training examples of trajectories selected by human drivers (e.g., trajectories driven by human drives, trajectories drawn or instructed by human reviewers of autonomously selected trajectories, etc.). In this manner, for example, the trajectory generator 658 can first generate higher-quality samples and as time progresses continue to generate longer-tail candidates. In this manner, for instance, generation can be terminated based on a latency budget and only skip generation of long-tail candidates.

The proposer 654 can output the pinned decisions 506 and the branched decisions 508 of FIG. 5. For example, the proposer 654 can include a decision drafter and a strategy generation system to generate the pinned decisions 506 and the branched decisions 508.

A decision drafter can enumerate decisions to be considered by the planning system 250 with respect to various objects in the environment. The decision drafter can process data from the context cache 652 or values generated by a backbone model to determine relevant actors or objects with respect to which the autonomous vehicle. The decision drafter can output a list of actors/objects or a list of decisions to make with respect to actors/objects.

The strategy generation system can reason over possible strategies for navigating an environment. A strategy can include a discrete decision that the autonomous vehicle can decide with respect to an object or other feature of an environment. A strategy can include a decision value for each decision that is before the autonomous vehicle (e.g., yield to one actor, not yield to another actor, etc.). The strategy generation system can enumerate candidate decision values for the decisions (from the decision drafter) and can obtain scores respectively corresponding to the candidate decision values. Pinning logic can process the candidate decision values and their respectively corresponding scores to determine which, if any, decisions should be pinned and which, if any, decisions should be branched. The pinning logic can “pin” high confidence decisions to a high confidence value and allow lower confidence decisions (e.g., branched decisions 508) to branch over multiple candidate decision values downstream for further evaluation.

The proposed trajectories 660 can describe a motion of the autonomous vehicle through the environment. A respective trajectory can describe a path of the autonomous vehicle through the environment over a time period. A respective trajectory can describe a control parameter for controlling the autonomous vehicle to move along a path through the environment. In this manner, for instance, a trajectory can implicitly represent a path in terms of the control parameters used to cause the autonomous vehicle to traverse the path. For instance, a respective trajectory can include waypoints of the path, or the respective trajectory cannot contain waypoints of the path. The proposed trajectories 660 can be parameterized in terms of a basis path and lateral offsets from that basis path over time.

The proposed trajectories 660 can include both short-term and long-term trajectories. As described herein, the short-term trajectories can include denser trajectories that are executable by the autonomous vehicle. The long-term trajectories can include coarser trajectories that may include fewer waypoints. Thus, the long-term trajectories may be trajectories not that are executable (or are not preferably executed) by the autonomous vehicle, but rather include artificial trajectories that help simulate a particular end state of the autonomous vehicle at a further point in time (e.g., beyond the end state of the short-term trajectory).

The ranker 662 can be or include a model that ingests scene context (e.g., from the context cache 452) and outputs the selected trajectory 668 for the autonomous vehicle to execute with the control system 260. The ranker 662 can include machine-learned components in the model. Machine-learned components can perform inference over inputs to generate outputs. The ranker 662 can include hand-tuned or engineered components.

The machine-learned components 664 can include one or more machine-learned models or portions of a model (e.g., a layer of a model, an output head of a model, a branch of a model, etc.). One or more of the machine-learned components 664 can be configured to ingest data based on the context cache 652.

The machine-learned components 664 can be configured to perform various different operations. The machine-learned components 664 can perform scene understanding operations. For instance, one or more of the machine-learned components 664 can reason over a scene presented in the context cache 652 to form an understanding of relevant objects and actors to the planning task.

The machine-learned components 664 can perform forecasting operations. For instance, one or more of the machine-learned components 664 can generate forecasted movements for one or more actors in the environment (e.g., for actors determined to be relevant). The forecasts can include marginal forecasts of actor behavior.

Forecasts in the ranker 662 can be generated in various levels of detail. For instance, example forecasts for the ranker 662 can be two-, three-, or four-dimensional. An example forecast for a respective actor can indicate a position of an actor over time. A two-dimensional forecast can include a longitudinal position over time. A three-dimensional forecast can include longitudinal and lateral positions over time. A four-dimensional forecast can include movement of a volume (e.g., actor bounding box) over time.

The machine-learned components 664 can generate forecasts conditioned on the candidate behavior (e.g., strategies, trajectories) of the autonomous vehicle. For instance, the machine-learned model components 664 can process the proposed trajectories 660 to generate a plurality of forecasted states of the environment respectively based on the plurality of candidate trajectories.

The ranker 662 can also forecast actor states using sampling. For instance, in the same manner that the proposer 654 outputs potential autonomous vehicle trajectories and the ranker 662 evaluates the proposals, the ranker 662 can include an instance of the proposer (or a different proposer) to propose actor trajectories. The ranker 662 can evaluate the proposals to determine a likely actor trajectory for a given situation. In this manner, for instance, the ranker 662 can also forecast actor states using sampling.

The trajectory coster 666 can perform costing operations. The trajectory coster 666 can perform costing operations using the machine-learned model components 664. The machine-learned model components 664 can process a candidate trajectory and generate a score associated with the trajectory. The score can correspond to an optimization target, such that ranking the trajectories based on the score can correspond to ranking the trajectories in order of preference or desirability. The machine-learned components 664 can include learned cost functions. The trajectory coster 666 can cost trajectories based on forecasts generated using the machine-learned model components 664.

The pinned decisions 506 can improve an efficiency of costing multiple candidate trajectories. For example, the trajectory coster 666 can cache constraints or cost surfaces evaluated for the pinned decisions 506 and only compute additional constraints on the branched decisions 508.

The trajectory coster 666 can perform costing operations to determine a cost of a short-term trajectory based on an associated long-term trajectory. In doing so, the costs applied for a long-term trajectory may be more limited or different from the costs applied for a short-term trajectory. For example, given the coarser nature of the long-term trajectory, the costs for jerk motion or lateral acceleration may not be applied or down weighted, whereas such costs are determined for any short-term trajectories.

The trajectory coster 666 can also include engineered cost functions. Example engineered cost functions can include actor envelop overlap, following distance, etc.

The selected trajectory 668 can correspond to a trajectory selected based on outputs of the trajectory coster 666. For instance, the trajectory coster 666 can generate scores for a plurality of candidate trajectories, and the selected trajectory 668 can be selected based on the scores. This can include, for example, selecting the lowest cost short-term trajectory 668, which has considered the costs for an associated long-term trajectory.

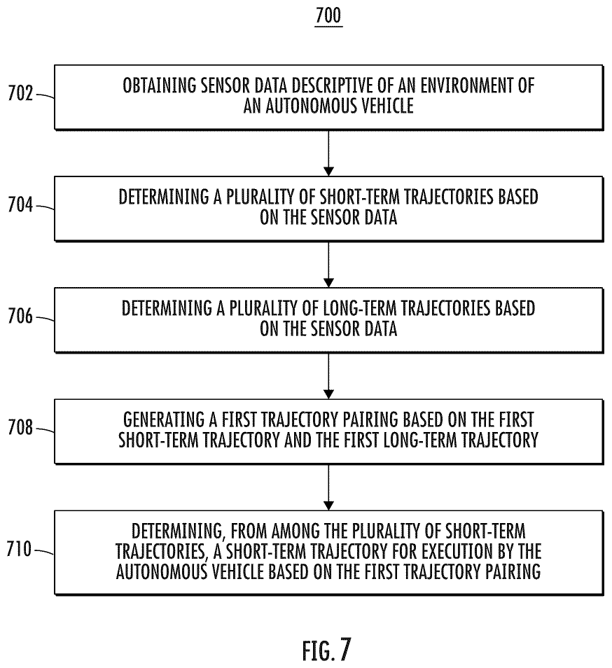

FIG. 7 is a flowchart of method 700 for trajectory selection according to aspects of the present disclosure. As described below, one or more portion(s) of the method 700 can be implemented by a computing system that includes one or more computing devices such as, for example, the computing systems described with reference to the other figures (e.g., autonomous platform 110, vehicle computing system 180, remote system(s) 160, motion planning system 400, system 500, a system of FIG. 13, etc.). Each respective portion of the method 700 can be performed by any (or any combination) of one or more computing devices. Moreover, one or more portion(s) of method 700 can be implemented on the hardware components of the device(s) described herein.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. To the extent that FIG. 7 is described with reference to elements/terms described with respect to other systems and figures it is for exemplary illustrated purposes and is not meant to be limiting. One or more portions of method 700 can be performed additionally, or alternatively, by other systems.

At 702, example method 700 can include obtaining sensor data descriptive of an environment of an autonomous vehicle. For instance, sensor data can include sensor data 204, input data 402, etc. A computing system may obtain the sensor data from sensors on the autonomous vehicle, other vehicles, and/or environmental sensors. The sensor data can include image data, LIDAR data, inertial measurement unit data, infrared data, sonar data, radar data, and/or other sensor data. The sensor data may include data generated and/or obtained within a particular timespan (e.g., an immediately previous dataset, a set of previously obtained datasets, and/or historical dataset).

At 704, example method 700 can include determining a plurality of short-term trajectories based on the sensor data. As described herein, a computing system can generate trajectories for the autonomous vehicle within an environment while avoiding interference with objects within the environment and traveling with respect to any applicable boundaries (e.g., road lanes, etc.), as discussed herein. The computing system can generate trajectories to accomplish end goals such as lane changes, merges, etc.

The plurality of short-term trajectories can include a first short-term trajectory that is descriptive of a first candidate short-term motion path for the autonomous vehicle from an initial state to a first end state. For example, the first short-term trajectory can include a candidate motion path that includes waypoints for the autonomous vehicle from t0 to t0+5 s. The waypoints of the first short-term trajectory may occur every 0.5 seconds or less.

The computing system can generate the plurality of short-term trajectories based on a plurality of determined features for an environment. These features can include actor state information, autonomous vehicle state information, and/or map data. For example, the computing system can process state information (e.g., state information associated with the autonomous vehicles and/or other actors in the environment) and/or map data to generate a plurality of short-term trajectories for traversing an environment. In some implementations, the computing system can perform short-term trajectory generation based on autonomous vehicle state information and map data alone, and the computing system can then evaluate the plurality of short-term trajectories based on outputs of a forecasting model that can be trained to determine predicted actions of the one or more other actors in the environment. In some implementations, the forecasting model can include one or more graph neural networks.

At 706, example method 700 can include determining a plurality of long-term trajectories based on the sensor data. The plurality of long-term trajectories can include a first long-term trajectory that is descriptive of a first candidate long-term motion path for the autonomous vehicle from the initial state to a second end state. A time span between the initial state and the second end state can be longer than a time span between the initial state and the first end state. For example, as described herein, the first long-term trajectory can include a candidate motion path that includes waypoints for the autonomous vehicle from t0 to t0+25 s.

The first long-term trajectory can be coarser than the short-term trajectory. For example, the waypoints of the first long-term trajectory may occur every 1 second, while the waypoints of the first short-term trajectory may occur every 0.5 seconds. The waypoints of the first long-term trajectory may become less frequent as the trajectory gets further out in time.

The plurality of long-term trajectories can be determined based on strategy data associated with a motion goal of the autonomous vehicle. A motion goal can be associated with a desired destination and/or waypoint. The computing system can obtain input data descriptive of the motion goal, which can then be processed by the computing system to generate strategy data descriptive of one or more strategies. The strategy data can include one or more determined routes, paths, etc. for achieving the motion goal.

The computing system can determine the plurality of short-term trajectories and the plurality of long-term trajectories separately. For example, the computing system may determine the plurality of short-term trajectories and the plurality of long-term trajectories independently of one another. In some implementations, the computing system may determine the plurality of long-term trajectories without referencing, determining, and/or obtaining the plurality of short-term trajectories. In some implementations, the computing system may leverage different models, heuristics, and/or functions for determining the plurality of short-term trajectories and the plurality of long-term trajectories. For example, the computing system may determine the plurality of short-term trajectories by processing sensor data with a first machine-learned model and may determine the plurality of long-term trajectories by processing the sensor data with a second machine-learned model. The first machine-learned model and the second machine-learned model may differ. The different machine-learned models can differ in architecture, training, size, and/or storage location. In some implementations, the computing system may weight, filter, and/or process the sensor data differently for short-term trajectories and long-term trajectories.

The computing system can determine the plurality of short-term trajectories and the long-term trajectory in parallel. For example, the computing system may perform the determination of short-term trajectories and long-term trajectories at the same time by leveraging a first set of computational resources for performing short-term trajectory determination and a second set of computational resources for performing long-term trajectory determination.

In some implementations, the quantity of short-term trajectories within the plurality of short-term trajectories can be greater than the quantity of long-term trajectories within the plurality of long-term trajectories. For example, the computing system may limit the quantity of candidate long-term trajectories that are generated, to save computational resources. Alternatively and/or additionally, environmental factors (e.g., traffic, nearing a turn and/or destination, and/or road closures) may reduce the quantity of potential diverse long-term trajectories. The quantity disparity may be based on the level of granularity of the short-term trajectories being higher, while the long-term trajectory determinations are coarse-grained determinations.

A computing system can determine the plurality of long-term trajectories by processing the sensor data with a machine-learned forecasting model to determine the plurality of long-term trajectories. In some cases, the forecasting model may be a machine-learned graph neural network. The machine-learned graph neural network may be trained to encode state and motion information about actors and the autonomous vehicle into a graph representation and process the graph representation to generate goal locations and other forecasts for the actors and autonomous vehicle.

At 708, example method 700 can include generating a first trajectory pairing based on the first short-term trajectory and the first long-term trajectory. The trajectory pairing can include a first portion that is defined by the short-term trajectory that spans from the initial state to the first end state and a second portion that is defined by a segment of the long-term trajectory that spans from the first end state to the second end state. As described herein, the initial state can be associated with an initial time. The first end state of the first short-term trajectory can be associated with a first time. The second end state of the second long-term trajectory can be associated with a second time, that is after the first time.

A computing system can generate the first trajectory pairing by determining that the first short-term trajectory is associated with the first long-term trajectory based on a time dimension and a spatial dimension. The long-term trajectory can be the closest, of the plurality of long-term trajectories, to the short-term trajectory with respect to the time dimension and the spatial dimension. By way of example, a first short-term trajectory may cause the autonomous vehicle to maintain a first speed (e.g., within a zero to five seconds time frame) and perform a gradual lane change to the left beginning at a first time. A first long-term trajectory may cause the autonomous vehicle to maintain a first speed (e.g., within a zero to five seconds time frame) and perform a gradual lane change to the left beginning at the first time. The computing system can determine the temporal and spatial dimension overlap and generate a trajectory pair with the first short-term trajectory and the first long-term trajectory. In some implementations, the computing system may perform short-term and long-term trajectory association based on a determined location of the trajectories at a given time and/or a given time frame. The given time and/or the given time frame may be associated with an end portion of the short-term trajectory (e.g., the given time may be five seconds from the initial time, when the short-term trajectory is descriptive of a trajectory from zero to five seconds).

The computing system can generate the first trajectory pairing by stitching, linking, or otherwise associating respective portions from each of the short-term and long-term trajectories. This can produce a trajectory pairing that includes a first portion based on the short-term trajectory and second portion based on the long-term trajectory.

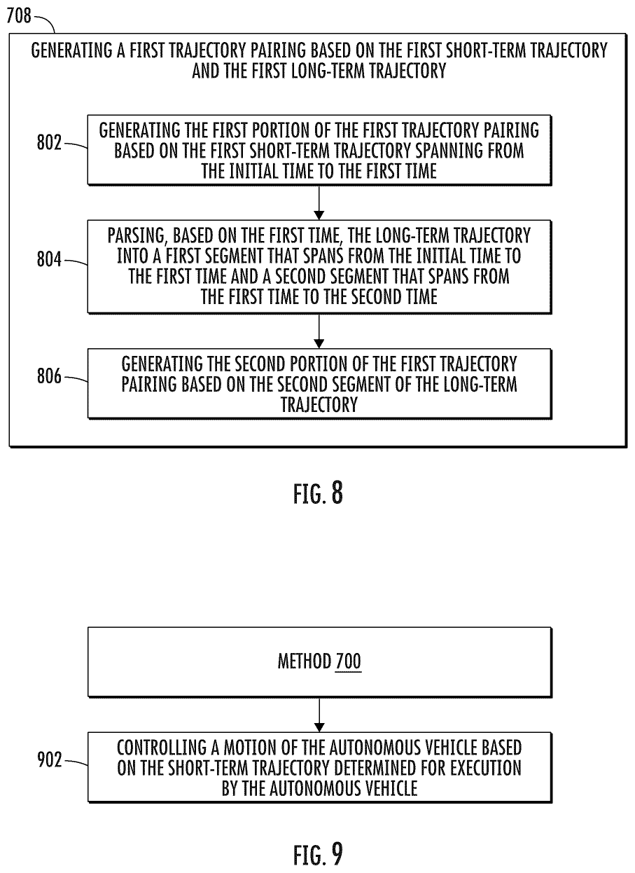

For example, with reference to FIG. 8, the computing system can generate a first portion of a first trajectory pairing based on the first short-term trajectory spanning from the initial time to the first time, at 802. To do so, the computing system can identify the entire first short-term trajectory spanning, which spans from t=0 to 5 s, as the first potion of the trajectory-pairing.

To generate the second portion of the trajectory pairing, the computing system can parse the long-term trajectory into segments, at 804. For example, based on the first time, the computing system can parse long-term trajectory into a first segment that spans from the initial time to the first time and a second segment that spans from the first time to the second time. The first segment can include the portion of the long-term trajectory that spans from the same timeframe as the short-term trajectory (e.g., 0 to 5 s), while the second segment can include the portion of the long-term trajectory that spans beyond the short-term trajectory (e.g., 0 to 25 s). The computing system can identify the second portion of the first trajectory pairing as the second segment of the long-term trajectory.

The computing system can generate a plurality of trajectory pairings, at 806. The plurality of trajectory pairings can be generated by utilizing one or more of the plurality of long-term trajectories for multiple pairings and/or one or more of the plurality of short-term trajectories for multiple pairings.

In some implementations, the computing system can generate a second trajectory pairing based on a different short-term trajectory and a different long-term trajectory than the first trajectory pairing. For example, the plurality of short-term trajectories can include a second short-term trajectory that is descriptive of a second candidate short-term motion path for the autonomous vehicle. The second short-term trajectory can be different from the first short-term trajectory in that it may include the autonomous vehicle nudging in the lane, changing lanes earlier, etc. The plurality of long-term trajectories can include a second long-term trajectory that is descriptive of a second candidate long-term motion path for the autonomous vehicle. The second long-term trajectory can be different from the first long-term trajectory in that the potential state of the autonomous vehicle at the end of the second long-term trajectory (e.g., its position within a roadway) may be different than that of the first long-term trajectory.

The computing system can generate the second trajectory pairing based on the second short-term trajectory and the second long-term trajectory. For example, as similarly described herein, a first portion of the second trajectory pairing can include the second short-term trajectory and as second portion of the second short-term trajectory can include a parsed segment of the second long-term trajectory (e.g., the segment spanning beyond the second short-term trajectory).

Returning to FIG. 8, at 802, example method 800 can include generating the first portion of the first trajectory pairing based on the first short-term trajectory spanning from the initial time to the first time. The initial time can be denoted as an origin time t₀ (e.g., 0 seconds). The first time can be denoted as a short time forward from the origin time t₀₊₅ (e.g., 5 seconds). The first portion of the trajectory pairing can include an entirety of a short-term trajectory of the plurality of short-term trajectories.

At 804, example method 800 can include parsing, based on the first time, the long-term trajectory into a first segment that spans from the initial time to the first time and a second segment that spans from the first time to the second time. The initial time can be denoted as an origin time t₀ (e.g., 0 seconds). The first time can be denoted as a short time forward from the origin time t₀₊₅ (e.g., 5 seconds). The second time can be denoted as a longer time (in comparison to the first time) forward from the origin time t₀₊₂₅ (e.g., 25 seconds). The parsing can be performed based on a determined end point for the short-term trajectories.

At 806, example method 800 can include generating the second portion of the first trajectory pairing based on the second segment of the long-term trajectory. The generation can include a piecewise trajectory generation and/or trajectory smoothing between the short-term trajectory and the second segment of the long-term trajectory.

Returning to FIG. 7, at 710, example method 700 can include determining, from among the plurality of short-term trajectories, a short-term trajectory for execution by the autonomous vehicle based on the first trajectory pairing. In some implementations, cost comparisons for short-term trajectories alone may cause a short-term trajectory to be selected that provides the lowest cost in the short-term but may be associated with an adverse action (e.g., a heavy braking action, a quick lane change, and/or a detour from an optimal route) in the long-term. Analysis based on long-term trajectories alone may fail to provide fine-grained detail, which may cause the short-term cost determination to be imprecise. The computing system can leverage trajectory pairings to understand the detailed intricacies of candidate short-term trajectories, while considering the potential long-term effects of the short-term trajectory.

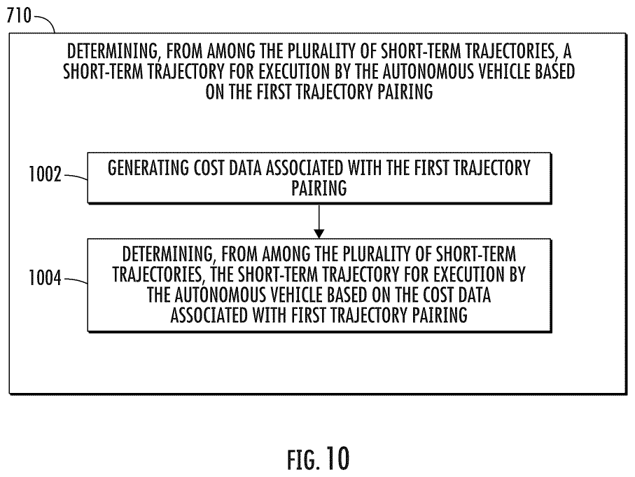

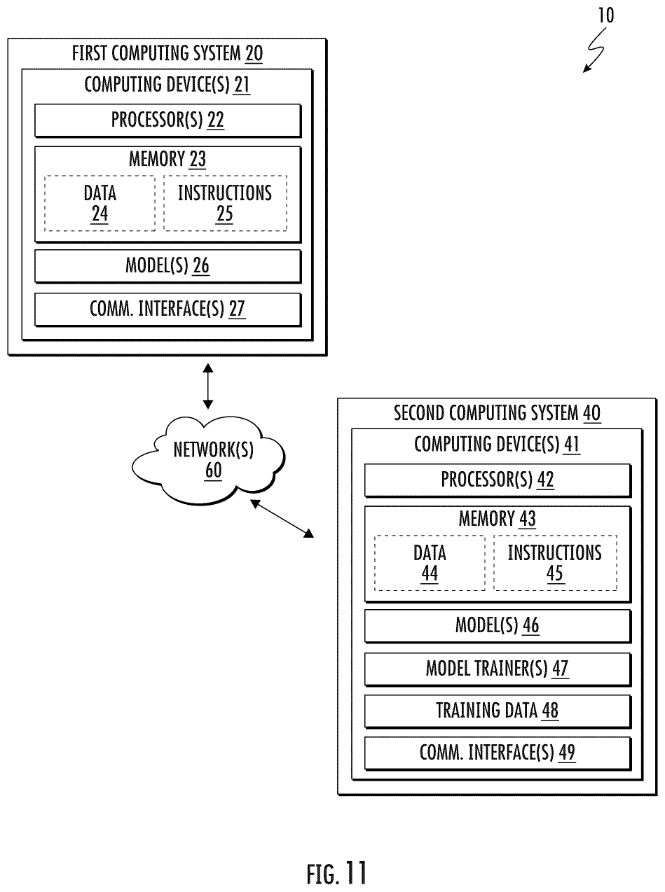

FIG. 10 provides example operations that may be performed by a computing system for determining a short-term trajectory for execution.

FIG. 10 depicts a flowchart of method 1000 for determining a short-term trajectory to execute according to aspects of the present disclosure. One or more portion(s) of the method 1000 can be implemented by a computing system that includes one or more computing devices such as, for example, the computing systems described with reference to the other figures (e.g., autonomous platform 110, vehicle computing system 180, remote system(s) 160, a system of FIG. 13, etc.). Each respective portion of the method 1000 can be performed by any (or any combination) of one or more computing devices. Moreover, one or more portion(s) of method 1000 can be implemented on the hardware components of the device(s) described herein (e.g., as in FIGS. 1, 2, 13, etc.), for example, to validate one or more systems or models.

FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1002, example method 1000 can include generating cost data associated with the first trajectory pairing. Determining the short-term trajectory for execution can include determining, from among the plurality of short-term trajectories, the short-term trajectory for execution by the autonomous vehicle based on the cost data associated with first trajectory pairing. In particular, the system can determine cost values for the plurality of short-term trajectories and the plurality of long-term trajectories, which the computing system may process to determine cost value(s) for the trajectory pairings.

The system may determine the costs for the plurality of short-term trajectories and the costs of the plurality of long-term trajectories based on a plurality of different cost determinations, which can include: boundary costs, control costs, actor costs, human driving costs, and/or other strategic costs. The boundary costs can penalize trajectories that include the autonomous vehicle driving too close to physical boundaries and lane lines. The control costs can penalize trajectories for (i) excessive jerk and acceleration and/or (ii) traveling at too high of a speed for the road curvature and conditions. The actor costs can penalize trajectories for getting too close to other actors and/or placing burden on other actors. The human driving costs can reward trajectories for making the same discrete decisions that a human driver would have made in the same situation. Other strategic costs may be associated with evaluating the trajectories for courtesy lane changes and/or avoidance of adjacent actors including adjacent vehicles and/or other adjacent road users (e.g., pedestrians, cyclists, etc.).

The cost determination for short-term trajectories and long-term trajectories may be uniform.

However, in some implementations, the cost determinations for short-term trajectories and long-term trajectories may differ. For example, short-term costs may include boundary costs, control costs and/or actor costs, while the long-term costs may include actor costs, human driving costs, other strategic costs, and/or progress costs. In some implementations, the costs evaluated may be the same, and the weighting of the different cost values may differ (e.g., actor costs may be given greater weight in the long-term, while control costs may be given greater weight in the short-term). By evaluating both short-term cost values and long-term cost values, the system can perform trajectory selection that is based on both short-term effects and potential long-term effects. In trajectory selection, the short-term cost values may be weighted more heavily when compared to long-term cost values.

For example, the cost data can be generated based on a prediction of whether the first trajectory pairing causes the autonomous vehicle to pass an adjacent vehicle. The computing system can generate the cost data based on a prediction of whether the first trajectory pairing causes the autonomous vehicle to be within a threshold distance of another vehicle in a same lane as the autonomous vehicle. Additionally and/or alternatively, the cost data can be descriptive of a plurality of subcosts. The plurality of subcosts can be associated with a plurality of different candidate route attributes. The plurality of different candidate route attributes can include one or more candidate route attributes that are associated with at least one of a vehicle inefficiency (e.g., inefficient use of energy via unnecessary/excessive braking and acceleration), a driving hazard (e.g., an action that has an increased likelihood for collision and/or damage to vehicle, which may include a tight merge and/or closely passing a stopped vehicle), or route inefficiency (e.g., additional turns with little to no time and/or distance benefit). In some implementations, the cost data can be descriptive of a determined proximity to one or more other objects in the environment for the first trajectory pairing and a determined fuel consumption for the first trajectory pairing.

At 1004, example method 1000 can include determining, from among the plurality of short-term trajectories, the short-term trajectory for execution by the autonomous vehicle based on the cost data associated with first trajectory pairing. The determination can include generating a plurality of trajectory pairings based on the plurality of short-term trajectories and the plurality of long-term trajectories, generating a plurality of cost datasets for the plurality of trajectory pairings, and determining a short-term trajectory for execution based on comparing the plurality of cost datasets for the plurality of trajectory pairings.

Determining the short-term trajectory for execution can include determining the short-term trajectory for execution by the autonomous vehicle based on the first trajectory pairing and the second trajectory pairing. For example, the computing system may compare the first trajectory pairing and the second trajectory pairing to determine which trajectory pairing utilizes the least resources (e.g., fuel and/or brakes), has the lowest cost, etc. In some implementations, the computing system may process the first trajectory pairing and the second trajectory pairing to determine which pairing provides less deviation from a determined strategy. The computing system can then select and execute the short-term trajectory associated with the trajectory pair that utilize the least resources and/or provides less deviation from the determined strategy.

The selected short-term trajectory may be executed to perform one or more navigational operations (e.g., braking, turning, accelerating, and/or maintaining speed and/or direction).

The output(s) of method 700 can be used in a variety of online and offline implementations. For example, with reference to FIG. 9, in some implementations, controlling a motion of the autonomous vehicle based on the short-term trajectory determined for execution by the autonomous vehicle can be implemented at 902 based on the candidate trajectories determined in method 700. For instance, method 700 can be implemented on a computing system affecting control over an autonomous vehicle, and the autonomous vehicle can execute a motion based on the short-term trajectory determined for execution by the autonomous vehicle.

At 902, example method 900 can include controlling a motion of the autonomous vehicle based on the short-term trajectory determined for execution by the autonomous vehicle. Controlling the motion of the autonomous vehicle can include providing one or more signals for the autonomous vehicle to operate in accordance with the short-term trajectory determined for execution by the autonomous vehicle. Controlling the motion can include speed control and/or direction control. Speed control can include maintaining the same speed, acceleration, and/or deceleration. Direction control can include maintaining an original direction and/or a change in direction.

In some offline examples, for instance, the motion planning system 400 can generate candidate trajectory pairs based on a plurality of short-term trajectories and a plurality of long-term trajectories. For instance, the motion planning system 400 can evaluate the output(s) against manually crafted strategies (e.g., based on expert demonstrations), manually labeled log data descriptive of expert navigation of driving scenarios, auto-labeled log data descriptive of expert navigation (e.g., collected by one or more sensors deployed in a real-world environment), and/or other trajectory pairs.

FIG. 11 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein for validating one or more systems or operational systems (e.g., the remote system(s) 160, the onboard computing system(s) 180, the autonomy system(s) 200, etc.).

In some implementations, the first computing system 20 can be included in an autonomous platform and be utilized to perform the functions of an autonomous platform as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. Memory 23 can include one or more non-transitory computer-readable storage media, such as RAM, ROM, EEPROM, EPROM, one or more memory devices, flash memory devices, etc., and combinations thereof.

Memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data, data associated with autonomy functions (e.g., data associated with the perception, planning, or control functions), simulation data, or any data or information described herein. In some implementations, the first computing system 20 can obtain data from one or more memory device(s) that are remote from the first computing system 20.

Memory 23 can store computer-readable instructions 25 that can be executed by the one or more processors 22. Instructions 25 can be software written in any suitable programming language or can be implemented in hardware. Additionally, or alternatively, instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include implementing trajectory generation, selection, execution, and autonomous platform motion control (e.g., as described herein).

In some implementations, the first computing system 20 can store or include one or more models 26. In some implementations, the models 26 can be or can otherwise include one or more machine-learned models (e.g., a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system(s) 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

Memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data, simulation data, simulated environmental scenes, simulated sensor data, data associated with vehicle trips/services, or any data or information described herein. In some implementations, the second computing system 40 can obtain data from one or more memory device(s) that are remote from the second computing system 40.

Memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system(s) 200 (e.g., localization, perception, planning, control, etc.) or other functionality associated with an autonomous platform (e.g., remote assistance, mapping, fleet management, trip/service assignment and matching, etc.).

In some implementations, second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system(s) 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system(s) 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software, or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 11 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, comprising:
(a) obtaining sensor data descriptive of an environment of an autonomous vehicle;
(b) determining a plurality of short-term trajectories based on the sensor data, the plurality of short-term trajectories comprising a first short-term trajectory that is descriptive of a first candidate short-term motion path for the autonomous vehicle from an initial state to a first end state;
(c) determining a plurality of long-term trajectories based on the sensor data, the plurality of long-term trajectories comprising a first long-term trajectory that is descriptive of a first candidate long-term motion path for the autonomous vehicle from the initial state to a second end state, wherein a time span between the initial state and the second end state is longer than a time span between the initial state and the first end state;
(d) generating a first trajectory pairing based on the first short-term trajectory and the first long-term trajectory, the trajectory pairing comprising
a first portion that is defined by the short-term trajectory that spans from the initial state to the first end state, and
a second portion that is defined by a segment of the long-term trajectory that spans from the first end state to the second end state; and
(e) determining, from among the plurality of short-term trajectories, a short-term trajectory for execution by the autonomous vehicle based on the first trajectory pairing.

2. The computer-implemented method of claim 1, wherein generating the first trajectory pairing comprises determining that the first short-term trajectory is associated with the first long-term trajectory based on a time dimension and a spatial dimension.

3. The computer-implemented method of claim 2, wherein the long-term trajectory is the closest, of the plurality of long-term trajectories, to the short-term trajectory with respect to the time dimension and the spatial dimension.

4. The computer-implemented method of claim 1, wherein the initial state is associated with an initial time, wherein the first end state of the first short-term trajectory is associated with a first time, wherein the second end state of the second long-term trajectory is associated with a second time that is after the first time, and wherein (d) comprises:
generating the first portion of the first trajectory pairing based on the first short-term trajectory spanning from the initial time to the first time;
parsing, based on the first time, the long-term trajectory into a first segment that spans from the initial time to the first time and a second segment that spans from the first time to the second time; and
generating the second portion of the first trajectory pairing based on the second segment of the long-term trajectory.

5. The computer-implemented method of claim 1, further comprising:
generating cost data associated with the first trajectory pairing; and
wherein (e) comprises determining, from among the plurality of short-term trajectories, the short-term trajectory for execution by the autonomous vehicle based on the cost data associated with first trajectory pairing.

6. The computer-implemented method of claim 5, wherein the cost data is generated based on a prediction of whether the first trajectory pairing causes the autonomous vehicle to pass an adjacent vehicle.

7. The computer-implemented method of claim 5, wherein the cost data is generated based on a prediction of whether the first trajectory pairing causes the autonomous vehicle to be within a threshold distance of another vehicle in a same lane as the autonomous vehicle.

8. The computer-implemented method of claim 5, wherein the cost data is descriptive of a plurality of subcosts, wherein the plurality of subcosts are associated with a plurality of different candidate route attributes, wherein the plurality of different candidate route attributes comprise one or more candidate route attributes that are associated with at least one of a vehicle inefficiency, a driving hazard, or route inefficiency.

9. The computer-implemented method of claim 5, wherein the cost data is descriptive of a determined proximity to one or more other objects in the environment for the first trajectory pairing and a determined fuel consumption for the first trajectory pairing.

10. The computer-implemented method of claim 1, wherein the plurality of long-term trajectories are determined based on strategy data associated with a motion goal of the autonomous vehicle.

11. The computer-implemented method of claim 1, wherein the plurality of short-term trajectories comprises a second short-term trajectory that is descriptive of a second candidate short-term motion path for the autonomous vehicle, and wherein the plurality of long-term trajectories comprises a second long-term trajectory that is descriptive of a second candidate long-term motion path for the autonomous vehicle, and wherein the method further comprises:
generating a second trajectory pairing based on the second short-term trajectory and the second long-term trajectory.

12. The computer-implemented method of claim 11, wherein (e) comprises determining the short-term trajectory for execution by the autonomous vehicle based on the first trajectory pairing and the second trajectory pairing.

13. The computer-implemented method of claim 1, wherein the plurality of short-term trajectories and the long-term trajectory are determined separately.

14. The computer-implemented method of claim 1, wherein the plurality of short-term trajectories and the long-term trajectory are determined in parallel.

15. The computer-implemented method of claim 1, wherein the quantity of short-term trajectories within the plurality of short-term trajectories is greater than the quantity of long-term trajectories within the plurality of long-term trajectories.

16. The computer-implemented method of claim 1, further comprising:
controlling a motion of the autonomous vehicle based on the short-term trajectory determined for execution by the autonomous vehicle.

17. The computer-implemented method of claim 15, wherein controlling the motion of the autonomous vehicle comprising providing one or more signals for the autonomous vehicle to operate in accordance with the short-term trajectory determined for execution by the autonomous vehicle.

18. The computer-implemented method of claim 1, wherein (b) comprises:
processing the sensor data with a machine-learned graph neural network model to determine the plurality of short-term trajectories.

19. An autonomous vehicle control system for controlling an autonomous vehicle, the autonomous vehicle control system comprising:
one or more processors; and
one or more non-transitory computer-readable media storing instructions that are executable by the one or more processors to cause the autonomous vehicle control system to perform operations, the operations comprising:
(a) obtaining sensor data descriptive of an environment of the autonomous vehicle;
(b) determining a plurality of short-term trajectories based on the sensor data, the plurality of short-term trajectories comprising a first short-term trajectory that is descriptive of a first candidate short-term motion path for the autonomous vehicle from an initial state to a first end state;
(c) determining a plurality of long-term trajectories based on the sensor data, the plurality of long-term trajectories comprising a first long-term trajectory that is descriptive of a first candidate long-term motion path for the autonomous vehicle from the initial state to a second end state, wherein a time span between the initial state and the second end state is longer than a time span between the initial state and the first end state;
(d) generating a first trajectory pairing based on the first short-term trajectory and the first long-term trajectory, the trajectory pairing comprising
a first portion that is defined by the short-term trajectory that spans from the initial state to the first end state, and
a second portion that is defined by a portion of the long-term trajectory that spans from the first end state to the second end state; and
(e) determining, from among the plurality of short-term trajectories, a short-term trajectory for execution by the autonomous vehicle based on the first trajectory pairing.

20. One or more non-transitory computer-readable media storing instructions that are executable by one or more processors to cause an autonomous vehicle control system to perform operations, the operations comprising:
(a) obtaining sensor data descriptive of an environment of an autonomous vehicle;
(b) determining a plurality of short-term trajectories based on the sensor data, the plurality of short-term trajectories comprising a first short-term trajectory that is descriptive of a first candidate short-term motion path for the autonomous vehicle from an initial state to a first end state;
(c) determining a plurality of long-term trajectories based on the sensor data, the plurality of long-term trajectories comprising a first long-term trajectory that is descriptive of a first candidate long-term motion path for the autonomous vehicle from the initial state to a second end state, wherein a time span between the initial state and the second end state is longer than a time span between the initial state and the first end state;
(d) generating a first trajectory pairing based on the first short-term trajectory and the first long-term trajectory, the trajectory pairing comprising
a first portion that is defined by the short-term trajectory that spans from the initial state to the first end state, and
a second portion that is defined by a portion of the long-term trajectory that spans from the first end state to the second end state; and
(e) determining, from among the plurality of short-term trajectories, a short-term trajectory for execution by the autonomous vehicle based on the first trajectory pairing.
